(19) United States
(12) Patent Application Publication
(10) Pub. No.: US 2016/0179472 A1
(43) Pub. Date: Jun. 23, 2016

(54) RANDOM NUMBER GENERATION DEVICE AND METHOD FOR GENERATING RANDOM NUMBER

(71) Applicant: MegaChips Corporation, Osaka-shi (JP)

(72) Inventor: Takahiko SUGAHARA, Osaka-shi (JP)

(73) Assignee: MegaChips Corporation, Osaka-shi (JP)

(21) Appl. No.: 14/974,081

(22) Filed: Dec. 18, 2015

(30) Foreign Application Priority Data
Dec. 19, 2014 (JP) 2014-258121
Dec. 26, 2014 (JP) 2014-266706
Dec. 26, 2014 (JP) 2014-266707
Jan. 9, 2015 (JP) 2015-003677

(51) Int. Cl. G06F 7/58

(52) U.S. Cl. CPC G06F 7/58

(57) ABSTRACT

A random number generation device includes a circuitry configured to output an output value of alternating 0 and 1 of two-valued logic, determine a sampling timing by generating data in which values change irregularly based on the output value, and generate a random number by sampling the output value at the sampling timing.

### CROSS REFERENCE TO RELATED APPLICATIONS

The present application is based on, and claims priority from Japanese Patent Application Serial Numbers 2014-258121, 2014-266706, 2014-266707, and 2015-003677, the disclosure of which is hereby incorporated by reference herein in its entirety.

### BACKGROUND

1. Technical Field

The present disclosure relates to random number generation devices and methods for generating random number, and more particularly, to a device and a method for generating true random numbers.

2. Related Art

With recent development in information technology, crimes by a third party such as eavesdropping, manipulation, and impersonation show an increasing trend. Information security by encryption is thus of increasing importance, and use of random numbers is indispensable in encryption.

Pseudo random numbers generated by arithmetic operations using computational expressions with combinations of functions have been generally used, which may possibly cause artificial leakage of functions or initial settings, or allow a third party to predict patterns for generating random numbers. Thus true random numbers with high impossibility of reproduction and prediction have been desired instead of pseudo random numbers.

A general true random number generator generates a true random number by outputting an output value of alternating 0 and 1 of two-valued logic from a ring oscillator and sampling the output value with a shift register using a predetermined sampling clock.

JP2005-174206A describes a true random number generation device that generates a sampling clock of an integer multiple of a system clock on the basis of a random number output from a random number output register, and samples an output value of an oscillator using the sampling clock, so as to generate a random number with the random number output register.

### SUMMARY

A random number generation device according to an aspect of the present disclosure includes a circuitry configured to output an output value of alternating 0 and 1 of two-valued logic, determine a sampling timing by generating data in which a value changes irregularly based on the output value, and generate a random number by sampling the output value at the sampling timing.

A method for generating a random number according to another aspect of the present disclosure includes generating an output value of alternating 0 and 1 of two-valued logic, determining a sampling timing by generating data in which a value changes irregularly based on the generated output value, and generating a random number by sampling the generated output value at the determined sampling timing.

A random number generation device according to another aspect of the present disclosure includes an oscillation circuit configured to output an output value of alternating 0 and 1 of two-valued logic, a controller configured to determine a sampling timing by generating data in which a value changes irregularly based on the output value from the oscillation circuit, and a random number generation circuit configured to generate a random number by sampling the output value from the oscillation circuit at the sampling timing determined by the controller.

### BRIEF DESCRIPTION OF THE DRAWINGS

FIG. 1 is a diagram illustrating a configuration of a random number generation device according to Embodiment 1-1 of the present disclosure.

FIG. 2 is a diagram illustrating a configuration of an oscillation circuit.

FIG. 3 is a diagram illustrating a configuration of a ring oscillator.

FIG. 4 is a diagram illustrating a configuration of a shift register.

FIG. 5 is a diagram illustrating a configuration of a random number generation device according to Embodiment 1-2 of the present disclosure.

FIG. 6 is a diagram illustrating a configuration of a random number generation device according to Embodiment 1-3 of the present disclosure.

FIG. 7 is a diagram illustrating a configuration of a random number generation device according to Embodiment 1-4 of the present disclosure.

FIG. 8 is a diagram illustrating a configuration of a random number generation device according to Embodiment 1-5 of the present disclosure.

FIG. 9 is a diagram illustrating a configuration of a random number generation device according to Embodiment 2-1 of the present disclosure.

FIG. 10 is a diagram illustrating a configuration of a sampling circuit.

FIG. 11 is a diagram illustrating a configuration of an oscillation circuit.

FIG. 12 is a diagram illustrating a configuration of a random number generation device according to Embodiment 2-2 of the present disclosure.

FIG. 13 is a diagram illustrating a configuration of an oscillation circuit.

FIG. 14 is a diagram illustrating a configuration of a random number generation device according to Embodiment 2-3 of the present disclosure.

FIG. 15 is a diagram illustrating a configuration of an oscillation circuit.

FIG. 16 is a diagram illustrating a configuration of a random number generation device according to Embodiment 2-4 of the present disclosure.

FIG. 17 is a diagram illustrating a configuration of an oscillation circuit.

FIG. 18 is a diagram illustrating a configuration of a first modification of the random number generation device.

FIG. 19 is a diagram illustrating a configuration of a second modification of the random number generation device.

FIG. 20 is a diagram illustrating a configuration of a third modification of the random number generation device.

FIG. 21 is a diagram illustrating a configuration of a fourth modification of the random number generation device.

FIG. 22 is a diagram illustrating a configuration of a random number generation device according to Embodiment 3-1 of the present disclosure.

FIG. 23 is a diagram illustrating a configuration of an oscillation circuit.

FIG. 24 is a diagram illustrating a configuration of a sampling circuit.

FIG. 25 is a diagram illustrating a configuration of the failure processing unit.

FIG. 26 is a diagram illustrating a detailed configuration of a detection circuit.

FIG. 27 is a diagram illustrating a detailed configuration of a failure correction circuit.

FIG. 28 is a diagram illustrating a detailed configuration of a determination circuit.

FIG. 29 is a diagram illustrating a result of toggle detection by the detection circuit.

FIG. 30 is a diagram illustrating a failure correction signal generated by the failure correction circuit.

FIG. 31 is a diagram illustrating a result of toggle detection by the detection circuit.

FIG. 32 is a diagram illustrating a configuration of a random number generation device according to Embodiment 3-2 of the present disclosure.

FIG. 33 is a diagram illustrating a configuration of an oscillation circuit.

FIG. 34 is a diagram illustrating a configuration of a failure processing unit.

FIG. 35 is a diagram illustrating a detailed configuration of a frequency correction circuit.

FIG. 36 is a diagram illustrating a result of toggle detection by a detection circuit.

FIG. 37 is a diagram illustrating a failure correction signal generated by the failure correction circuit.

FIG. 38 is a diagram illustrating a frequency correction signal generated by the frequency correction circuit.

FIG. 39 is a diagram illustrating a result of toggle detection by the detection circuit.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

True random number generators generally sample an output value from a ring oscillator with a shift register to generate a true random number. The trueness (impossibility of reproduction and impossibility of prediction) of the generated random number depends on accuracy of sampling. Random numbers with high trueness cannot be generated by simply sampling with a sampling clock having a constant period.

The present disclosure is directed to obtaining a random number generation device and a method for generating a random number that achieve a random number with high trueness by appropriately controlling a sampling timing.

A random number generation device according to an aspect of the present disclosure includes an oscillation circuit configured to output an output value of alternating 0 and 1 of two-valued logic, a controller configured to determine a sampling timing by generating data in which a value changes irregularly based on the output value from the oscillation circuit, and a random number generation unit configured to generate a random number by sampling the output value from the oscillation circuit at the sampling timing determined by the controller.

In the random number generation device according to this aspect, the controller determines a sampling timing by generating data in which values change irregularly based on the output value from the oscillation circuit. Thus the controller can irregularly vary the sampling timing, which in consequence enhances the trueness (impossibility of reproduction and impossibility of prediction) of the random number generated in the random number generation unit. Moreover, the output value from the oscillation circuit varies depending on environmental factors such as ambient temperature or humidity, and the sampling timing determined by the controller varies accordingly, which in consequence enhances the trueness of the random number. Furthermore, in comparison with generating a sampling clock by dividing a system clock frequency, circuit design is facilitated by using one clock, and minute setting of a sampling timing is enabled without limitation to an integer multiple of the system clock, and thus the trueness of the random number is enhanced.

In some embodiments, the controller includes a pseudo random number generator configured to generate a pseudo random number, employing the output value from the oscillation circuit as a seed.

According to such embodiments, the controller includes a pseudo random number generator configured to generate a pseudo random number, employing the output value from the oscillation circuit as a seed. Since the output value from the oscillation circuit changes every second, the pseudo random number generated employing this value as a seed also changes every second. In consequence, as a value of the pseudo random number, data in which values change irregularly is effectively generated.

In some embodiments, the controller further includes a counter configured to count a system clock from a predetermined initial value. The controller is configured to output a control signal for causing the random number generation unit to perform sampling of the output value from the oscillation circuit, when a count number of the system clock by the counter matches a value of the pseudo random number generated by the pseudo random number generator.

According to such embodiments, the controller outputs a control signal for causing the random number generation unit to perform sampling of the output value from the oscillation circuit, when a count number of the system clock by the counter matches a value of the pseudo random number generated by the pseudo random number generator. The random number generation unit samples the output value from the oscillation circuit upon receipt of an input of the control signal, which enables the random number generation unit to generate a random number.

In some embodiments, the controller further includes a counter configured to count a system clock, employing the output value from the oscillation circuit as an initial value. The controller is configured to output a control signal for causing the random number generation unit to perform sampling of the output value from the oscillation circuit, when a count number of the system clock by the counter matches a value of the pseudo random number generated by the pseudo random number generator.

According to such embodiments, the controller outputs a control signal for causing the random number generation unit to perform sampling of the output value from the oscillation circuit, when a count number of the system clock by the counter matches a value of the pseudo random number generated by the pseudo random number generator. The random number generation unit samples the output value from the oscillation circuit upon receipt of an input of the control signal, which enables the random number generation unit to generate a random number. The counter employs the output value from the oscillation circuit as the initial value. Since the output value from the oscillation circuit changes every second, the initial value of the counter also changes every second. Even if an identical value of the pseudo random number is employed, since the count number of the system clock that matches the value of the pseudo random number varies, timing for the controller to output the control signal also varies, which in consequence enhances the trueness of the random number.

In some embodiments, the controller is configured to output a control signal for causing the random number generation unit to perform sampling of the output value from the oscillation circuit, when a value of the pseudo random number generated by the pseudo random number generator matches a preset predetermined value.

According to such embodiments, the controller outputs a control signal for causing the random number generation unit to perform sampling of the output value from the oscillation circuit, when a value of the pseudo random number generated by the pseudo random number generator matches a preset predetermined value. The random number generation unit samples the output value from the oscillation circuit upon receipt of an input of the control signal, which enables the random number generation unit to generate a random number. Without a counter for counting a system clock, a circuit configuration is simplified.

In some embodiments, the oscillation circuit and the pseudo random number generator are configured to suspend an operation in a period when generation of a random number by the random number generation unit is not required.

According to such embodiments, operations of the oscillation circuit and the pseudo random number generator are suspended in a period when generation of a random number by the random number generation unit is not required. This effectively reduces power consumption.

In some embodiments, the controller includes a counter configured to count a system clock, employing the output value from the oscillation circuit as an initial value.

According to such embodiments, the controller includes a counter configured to count a system clock, employing the output value from the oscillation circuit. Since the output value from the oscillation circuit changes every second, the initial value of the counter also changes every second. In consequence, as the number of counts from an initial value to a target value of the system clock by the counter, data in which values change irregularly is effectively generated.

In some embodiments, the controller further includes a pseudo random number generator configured to generate a pseudo random number, employing a predetermined value as a seed. The controller is configured to output a control signal for causing the random number generation unit to perform sampling of the output value from the oscillation circuit, when a count number of the system clock by the counter matches a value of the pseudo random number generated by the pseudo random number generator.

According to such embodiments, the controller outputs a control signal for causing the random number generation unit to perform sampling of the output value from the oscillation circuit, when a count number of the system clock by the counter matches a value of the pseudo random number generated by the pseudo random number generator. The random number generation unit samples the output value from the oscillation circuit upon receipt of an input of the control signal, which enables the random number generation unit to generate a random number. The value of the pseudo random number generated by the pseudo random number generator (that is, a target value of the counter) changes every second. Even if an identical initial value of the counter is employed, since the number of counts count number of the system clock that matches the value of the pseudo random number varies, timing for the controller to output the control signal also varies, which in consequence enhances the trueness of the random number.

In some embodiments, the controller is configured to output a control signal for causing the random number generation unit to perform sampling of the output value from the oscillation circuit, when a count number of the system clock by the counter matches a preset predetermined value.

According to such embodiments, the controller outputs a control signal for causing the random number generation unit to perform sampling of the output value from the oscillation circuit, when a count number of the system clock by the counter matches a preset predetermined value. The random number generation unit samples the output value from the oscillation circuit upon receipt of an input of the control signal, which enables the random number generation unit to generate a random number. Since a target value of the counter is fixed at the predetermined value, without the pseudo random number generator for generating the target value, a circuit configuration is simplified.

In some embodiments, the oscillation circuit and the counter is configured to suspend an operation in a period when generation of a random number by the random number generation unit is not required.

According to such embodiments, operations of the oscillation circuit and the counter are suspended in a period when generation of a random number by the random number generation unit is not required. This effectively reduces power consumption.

A method for generating a random number according to another aspect of the present disclosure includes generating an output value of alternating 0 and 1 of two-valued logic, determining a sampling timing by generating data in which a value changes irregularly based on the generated output value, and generating a random number by sampling the generated output value at the determined sampling timing.

In the method for generating a random number according to this aspect, sampling timing is determined by generating data in which values change irregularly based on the generated output value. Thus the sampling timing can be irregularly varied, which in consequence enhances the trueness (impossibility of reproduction and impossibility of prediction) of the generated random number. In comparison with generating a sampling clock by dividing a system clock frequency, circuit design is facilitated by using one clock, and minute setting of a sampling timing is enabled without limitation to an integer multiple of the system clock, and thus the trueness of the random number is enhanced.

According to some embodiments of the present disclosure, a random number with high trueness is achieved by appropriately controlling a sampling timing.

As stated above, true random number generators generally sample an output value from a ring oscillator with a shift register to generate a true random number. Semiconductor devices, however, exhibit uneven variations in their properties. Since ring oscillators, which are a kind of semiconductor device, have different properties, the trueness (impossibility of reproduction and impossibility of prediction) of generated random numbers also exhibits variations. In other words, some ring oscillators generate appropriate random numbers with high trueness, while others do not, depending on their properties.

The present invention is also directed to obtaining a random number generation device and a method for generating a random number that achieve a random number with high trueness, irrespective of properties of an oscillation circuit.

A random number generation device according to another aspect of the present disclosure includes an oscillation circuit configured to output an output value of alternating 0 and 1 of two-valued logic, a random number generation circuit configured to generate a random number by sampling the output value from the oscillation circuit based on a predetermined sampling clock, and a first setting unit configured to variably set an oscillation frequency of the oscillation circuit.

In the random number generation device according to this aspect, the first setting unit variably sets an oscillation frequency of the oscillation circuit. If a random number shows low trueness due to properties of the oscillation circuit, a different frequency that leads to a random number with high trueness is employed, so that generation of a random number with high trueness is enabled irrespective of properties of the oscillation circuit. If a random number is not generated with an oscillation frequency set at shipment due to a failure or the like in a certain logical gate, another frequency is employed so as to generate a desired random number, which in consequence improves a reliability of the device.

In some embodiments, the first setting unit is configured to set the oscillation frequency of the oscillation circuit based on an externally received selection signal.

According to such embodiments, the first setting unit sets the oscillation frequency based on an externally received selection signal. If a random number shows low trueness at an inspection before shipment of a product, a frequency that would lead to a random number with high trueness is searched and this frequency is employed with the selection signal, so that a product that will generate a random number with high trueness is shipped. In consequence, an improvement in yield is expected.

In some embodiments, the first setting unit is configured to set the oscillation frequency of the oscillation circuit based on the random number generated by the random number generation circuit.

According to such embodiments, the first setting unit sets the oscillation frequency of the oscillation circuit based on the random number generated by the random number generation circuit. Since the oscillation frequency of the oscillation circuit irregularly varies corresponding to the random number generated by the random number generation circuit, the trueness of the generated random number is enhanced.

In some embodiments, the first setting unit is configured to set the oscillation frequency of the oscillation circuit based on every random number output from the random number generation circuit.

According to such embodiments, every time the random number generation circuit outputs a random number, the first setting unit sets the oscillation frequency of the oscillation circuit based on the random number. Since the oscillation frequency of the oscillation circuit varies every time the random number generation circuit outputs a random number, the trueness of the generated random number is further enhanced.

In some embodiments, the oscillation circuit includes a plurality of odd number of logical gates connected in serial. The first setting unit includes a selector having a plurality of input terminals. Each of the input terminals of the selector is configured to receive an output value from different one of the logical gates.

According to such embodiments, the oscillation circuit includes a plurality of odd number of logical gates connected in serial. The first setting unit includes a selector having a plurality of input terminals. Each of the input terminals of the selector receives an output value from different one of the logical gates. This achieves an oscillation circuit capable of variably setting an oscillation frequency with simple configuration at low cost.

In some embodiments, the random number generation device further includes a second setting unit configured to variably set an effective bus width of the output value from the oscillation circuit.

According to such embodiments, the second setting unit variably sets an effective bus width of the output value from the oscillation circuit. Thus the second setting unit outputs an output value having an effective bus width that is neither excessive nor deficient for a required bus width of an external device that obtains the random number, and the random number generation circuit samples the output value, so that the random number having a required bus width is efficiently generated in the random number generation circuit. In consequence, efficiency in sampling in the random number generation circuit is improved. Moreover, an output value having a minimum necessary effective bus width is output, so that power consumption is effectively reduced and malfunction caused by, for example, switching noise of clocks is suppressed.

In some embodiments, the random number generation device further includes a second setting unit configured to generate an output value having an N-bit bus width each bit of which alternates between 0 and 1 of two-valued logic, where N is a plural number, based on the output value from the oscillation circuit, and variably set an output bit position from the oscillation circuit in each bit of the N-bit output value.

According to such embodiments, the second setting unit generates an output value having a plurality of bits of bus width based on the output value from the oscillation circuit. The random number generation circuit generates a random number by sampling the output value from the second setting unit. Since the random number having a bus width of a plurality of bits is generated by the oscillation circuit, a circuit size is reduced, in comparison with using a plurality of oscillation circuits. The second setting unit variably sets an output bit position from the oscillation circuit in each bit of the N-bit output value. Since each bit of the N-bit output value can be in a different phase, the trueness of a generated random number is enhanced.

A method for generating a random number according to another aspect of the present disclosure includes generating an output value of alternating 0 and 1 of two-valued logic, generating a random number by sampling the generated output value based on a predetermined sampling clock, and variably setting a frequency of the generated output value.

In the method for generating a random number according to this aspect, a frequency of an output value from the oscillation circuit is variably set. If a random number shows low trueness due to properties of the oscillation circuit, a different frequency that leads to a random number with high trueness is employed, so that generation of a random number with high trueness is enabled irrespective of properties of the oscillation circuit. If a random number is not generated with an oscillation frequency set at shipment due to a failure or the like in a certain logical gate, another frequency is employed so as to generate a desired random number, which in consequence improves a reliability of the device.

According to some embodiments of the present disclosure, a random number with high trueness is achieved irrespective of properties of an oscillation circuit.

As stated above, true random number generators generally sample an output value from a ring oscillator with a shift register to generate a true random number. Since a bus width of random numbers required by an external device that obtains the random numbers differs depending on the device, if the bus width of an output value from a ring oscillator is fixed, a required bus width of an external device may not agree with an output bus width from the ring oscillator. Thus the number of bits a shift register obtains from a ring oscillator by one sampling may be excessive or deficient for the required bus width by the external device, in consequence efficiency of sampling in the shift register decreases.

The present disclosure is also directed to obtaining a random number generation device and method for generating a random number with improved efficiency in sampling in a random number generation circuit.

A random number generation device according to another aspect of the present disclosure includes an oscillation circuit configured to output an output value of alternating 0 and 1 of two-valued logic, a first setting unit configured to generate and output an output value having an N-bit bus width each bit of which alternates between 0 and 1 of two-valued logic, where N is a number greater than or equal to 1, based on the output value from the oscillation circuit, and a random number generation circuit configured to generate a random number by sampling the output value from the first setting unit based on a predetermined sampling clock. The first setting unit is configured to variably set an effective bus width of the output value from the first setting unit based on an externally received selection signal.

In the random number generation device according to this aspect, the first setting unit variably sets an effective bus width of the output value form the first setting unit based on an externally received selection signal. Thus the first setting unit outputs an output value having an effective bus width that is neither excessive nor deficient for a required bus width of an external device that obtains the random number, and the random number generation circuit samples the output value, so that the random number having a required bus width is efficiently generated in the random number generation circuit. In consequence, efficiency in sampling in the random number generation circuit is improved. Moreover, the first setting unit outputs an output value having a minimum necessary effective bus width, so that power consumption is effectively reduced and malfunction caused by, for example, switching noise of clocks is suppressed.

In some embodiments, the oscillation circuit includes a plurality of odd number of logical gates connected in serial. The first setting unit includes a selector having a plurality of input terminals. Each of the input terminals of the selector is configured to receive an output value from a different number of logical gates among all of the logical gates.

According to such embodiments, the oscillation circuit includes a plurality of odd number of logical gates connected in serial. The first setting unit includes a selector having a plurality of input terminals. Each of the input terminals of the selector receives an output value from a different number of logical gates among all of the logical gates. This achieves an oscillation circuit capable of variably setting an effective bus width of the output value with simple configuration at low cost.

A random number generation device according to another aspect of the present disclosure includes an oscillation circuit configured to output an output value of alternating 0 and 1 of two-valued logic, a first setting unit configured to generate and output an output value having an N-bit bus width each bit of which alternates between 0 and 1 of two-valued logic, where N is a plural number, based on the output value from the oscillation circuit, and a random number generation circuit configured to generate a random number by sampling the output value from the first setting unit based on a predetermined sampling clock. The first setting unit is configured to variably set an output bit position from the oscillation circuit in each bit of the N-bit output value.

In the random number generation device according to this aspect, first setting unit generates an output value having a plurality of bits of bus width based on the output value from the oscillation circuit. The random number generation circuit generates a random number by sampling the output value from the first setting unit. Since the random number having a bus width of a plurality of bits is generated by the oscillation circuit, a circuit size is reduced, in comparison with using a plurality of oscillation circuits. The first setting unit variably sets an output bit position from the oscillation circuit in each bit of the N-bit output value. Since each bit of the N-bit output value can be in a different phase, the trueness of a generated random number is enhanced.

In some embodiments, the oscillation circuit includes a plurality of odd number of logical gates connected in serial. The first setting unit includes a selector having a plurality of input terminals corresponding to each bit of the N-bit output value. Each input terminal of the selector is configured to receive an output value from N number of logical gates among all of the logical gates.

According to such embodiments, the oscillation circuit includes a plurality of odd number of logical gates connected in serial. The first setting unit includes a selector having a plurality of input terminals corresponding to each bit of the N-bit output value. Each input terminal of the selector receives an output value from N number of logical gates among all of the logical gates. This achieves an oscillation circuit capable of variably setting an output bit position with simple configuration at low cost.

In some embodiments, the random number generation device further includes a second setting unit configured to variably set an oscillation frequency of the oscillation circuit.

According to such embodiments, the second setting unit variably sets an oscillation frequency of the oscillation circuit. If a random number shows low trueness due to properties of the oscillation circuit, a different frequency that leads to a random number with high trueness is employed, so that generation of a random number with high trueness is enabled irrespective of properties of the oscillation circuit. If a random number is not generated with an oscillation frequency set at shipment due to a failure or the like in a certain logical gate, another frequency is employed so as to generate a desired random number, which in consequence improves a reliability of the device.

A method for generating a random number according to another aspect of the present disclosure includes generating a first output value of alternating 0 and 1 of two-valued logic, generating a second output value having an N-bit bus width each bit of which alternates between 0 and 1 of two-valued logic, where N is a number greater than or equal to 1, based on the first output value, and generating a random number by sampling the second output value based on a predetermined sampling clock, and variably setting an effective bus width of the second output value based on an externally received selection signal.

In the method for generating a random number according to this aspect, an effective bus width of the second output value is variably set based on an externally received selection signal. By generating a second output value having an effective bus width that is neither excessive nor deficient for a required bus width of an external device that obtains the random number and sampling the second output value, the random number having a required bus width is efficiently generated in the random number generation circuit. In consequence, efficiency in sampling in the random number generation circuit is improved. Moreover, an output value having a minimum necessary effective bus width is generated, so that power consumption is effectively reduced and malfunction caused by, for example, switching noise of clocks is suppressed.

According to some embodiments of the present disclosure, efficiency in sampling in the random number generation circuit is improved.

As stated above, true random number generators generally sample an output value from a ring oscillator with a shift register to generate a true random number. If a failure occurs in any of logical gates constituting a ring oscillator, the ring oscillator stops oscillation, and an output value from the ring oscillator is fixed to “0” or “1”. Random numbers cannot be generated by sampling such output value, and thus continuing to use a random number generator with a failure occurred in a logical gate may compromise security.

The present disclosure is also directed to obtaining a random number generation device and a method for generating a random number that help avoid continuous use of a device when it does not generate an appropriate random number.

A random number generation device according to another aspect of the present disclosure includes an oscillation circuit including a logical array including a plurality of odd number of logical gates connected in serial and being configured to output an output value of alternating 0 and 1 of two-valued logic, a random number generation circuit configured to generate a random number by sampling the output value from the oscillation circuit at a predetermined timing, and a detection circuit configured to detect a failure that occurs in any of the logical gates included in the logical array.

In the random number generation device according to this aspect, if a failure occurs in any of a plurality of logical gates included in a logical array, the detection circuit detects the failure. If the detection circuit detects a failure in any of the logical gates, an external device that uses a random number is notified of the failure, or alternatively, the failure is corrected in the random number generation device, which helps avoid continuous use of the random number generation device when it does not generate an appropriate random number.

In some embodiments, the detection circuit is configured to detect a failure in a logical gate by detecting an output value from a logical gate that does not toggle in a predetermined direction for each of the logical gates in the logical array.

According to such embodiments, the detection circuit detects a failure in a logical gate by detecting an output value from a logical gate that does not toggle in a predetermined direction, for each of the logical gates in the logical array. This achieves simple and dependable detection of a failure in a logical gate.

In some embodiments, the random number generation device further includes a failure notification unit configured to output a notification signal indicating that an output value from the random number generation device is invalid, if the detection circuit detects a failure in any of the logical gates.

According to such embodiments, the failure notification unit outputs a notification signal indicating that an output value from the random number generation device is invalid, if the detection circuit detects a failure in any of the logical gates. Thus an external device that uses a random number is enabled to suspend the use of the random number upon receipt of an input of the notification signal from the failure notification unit.

In some embodiments, the random number generation device further includes a failure correction circuit configured to correct the failure in any of the logical gates detected by the detection circuit.

According to such embodiments, the failure correction circuit corrects a failure, if the detection circuit detects a failure in any of the logical gates. Since the failure correction circuit corrects the failure in the logical gate and thereby the oscillation circuit outputs an appropriate output value, the random number generation circuit generates an appropriate random number based on the appropriate output value. This helps avoid continuous use of the random number generation device when it does not generate an appropriate random number.

A random number generation device according to another aspect of the present disclosure includes an oscillation circuit including a logical array including a plurality of odd number of logical gates connected in serial and being configured to output an output value of alternating 0 and 1 of two-valued logic, a random number generation circuit configured to generate a random number by sampling the output value from the oscillation circuit at a predetermined timing, and a failure correction circuit configured to correct a failure that occurs in any of the logical gates included in the logical array.

In the random number generation device according to this aspect, if a failure occurs in any of a plurality of logical gates included in the logical array, the failure correction circuit corrects the failure. Since the failure correction circuit corrects the failure in the logical gate and thereby the oscillation circuit outputs an appropriate output value, the random number generation circuit generates an appropriate random number based on the appropriate output value. This helps avoid continuous use of the random number generation device when it does not generate an appropriate random number.

In some embodiments, the failure correction circuit is configured to correct the failure by excluding an even number of logical gates including a failed logical gate from the logical array.

According to such embodiments, the failure correction circuit corrects the failure by excluding an even number of logical gates including a failed logical gate from the logical array. Correction of a failure in a logical gate is simply achieved by bypassing a failed logical gate to exclude from the logical array. By excluding an even number of logical gates, the logical array after exclusion includes an odd number of logical gates, and thus an output value from the oscillation circuit is correctly oscillated.

In some embodiments, the oscillation circuit further includes a plurality of auxiliary logical gate. The random number generation device further includes a frequency correction circuit configured to add as many auxiliary logical gates as logical gates excluded from the logical array by the failure correction circuit to the logical array.

According to such embodiments, the frequency correction circuit adds the same number of auxiliary logical gates as the number of logical gates excluded from the logical array by the failure correction circuit to the logical array. Since the number of logical gates constituting the logical array is the same between before and after exclusion, the oscillation frequency of the oscillation circuit is effectively maintained.

A method for generating a random number according to another aspect of the present disclosure includes generating an output value of alternating 0 and 1 of two-valued logic using a logical array including a plurality of odd number of logical gates connected in serial, generating a random number by sampling the generated output value at a predetermined timing, and detecting a failure that occurs in any of the logical gates included in the logical array.

In the method for generating a random number according to this aspect, if a failure occurs in any of the logical gates included in the logical array, the failure is detected. If a failure is detected in any of the logical gates, an external device that uses a random number is notified of the failure, or alternatively, the failure is corrected in the random number generation device, which helps avoid continuous use of the random number generation device when it does not generate an appropriate random number.

A method for generating a random number according to another aspect of the present disclosure includes generating an output value of alternating 0 and 1 of two-valued logic using a logical array including a plurality of odd number of logical gates connected in serial, generating a random number by sampling the generated output value at a predetermined timing, and correcting a failure that occurs in any of the logical gates included in the logical array.

In the method for generating a random number according to this aspect, if a failure occurs in any of a plurality of logical gates included in the logical array, the failure is corrected. Since an appropriate output value is output by correcting a failure, an appropriate random number is generated based on the appropriate output value. This helps avoid continuous use of the random number generation device when it does not generate an appropriate random number.

Some embodiments of the present disclosure help avoid continuous use of a random number generation device when it does not generate an appropriate random number.

These and other objects, features, aspects and advantages of the present disclosure will become more apparent from the following detailed description when taken in conjunction with the accompanying drawings.

### DESCRIPTION OF EMBODIMENTS

Embodiments of the present disclosure are described in detail below referring to the drawings. It should be noted that identical reference numerals throughout the drawings indicate identical or equivalent elements.

### Embodiment 1-1

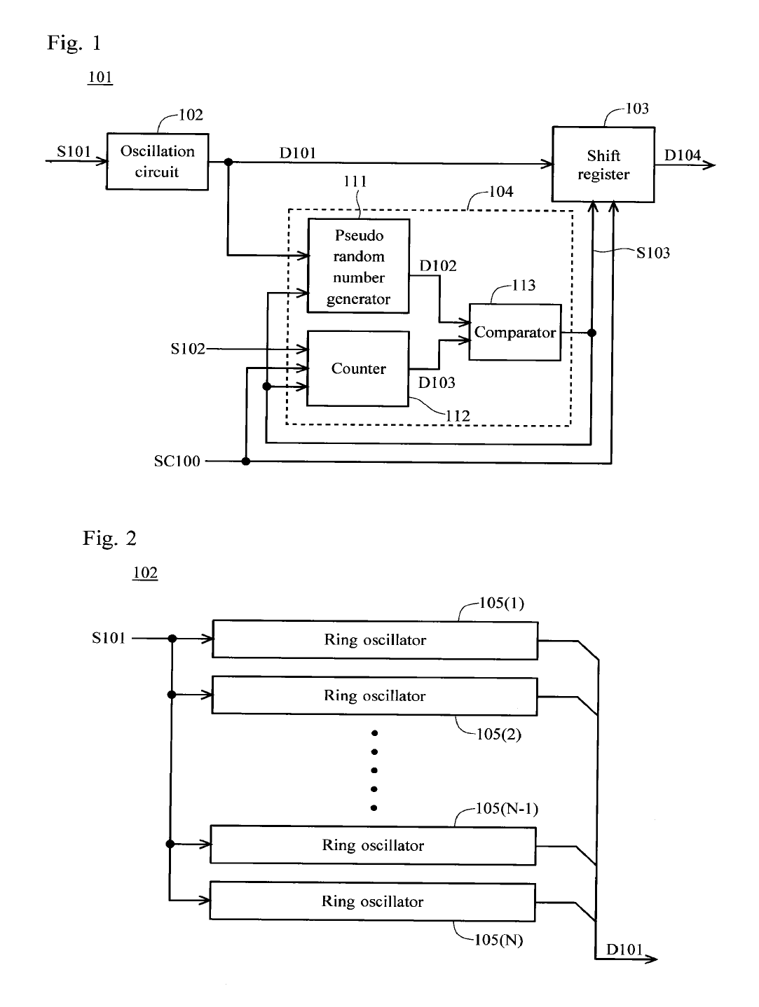

FIG. 1 is a diagram illustrating a configuration of a random number generation device 101 according to Embodiment 1-1 of the present disclosure. FIG. 1 illustrates a connection in the random number generation device 101 including an oscillation circuit 102, a shift register 103, and a controller 104. The controller 104 includes a pseudo random number generator 111, a counter 112, and a comparator 113. Multiple sets of pseudo random number generators 111 and counters 112 may be provided as a backup in case of a failure or a defect.

The oscillation circuit 102 outputs an N-bit output value D101, each bit of which alternates between 0 and 1 of two-valued logic. The controller 104 determines a sampling timing with a control signal S103, by generating data in which values change irregularly, on the basis of the output value D101 from the oscillation circuit 102. The shift register 103 functions as a random number generation unit which may include suitable logic, circuitry, interfaces and/or code that may be operable to sample the output value D101 from the oscillation circuit 102 at the sampling timing determined by the controller 104, so as to generate a true random number D104.

FIG. 2 is a diagram illustrating a configuration of the oscillation circuit 102. The oscillation circuit 102 includes multiple N number of ring oscillators 105(1) to 105(N) connected in parallel. Each ring oscillator 105 receives a common input of an enabling signal S101 for instructing a start of the operation of the oscillation circuit 102. Each ring oscillator 105 outputs a 1-bit output value of alternating 0 and 1 of two-valued logic, the N ring oscillators 105(1) to 105(N) being connected in parallel, so that the output value D101 having N bits in total is output from the oscillation circuit 102.

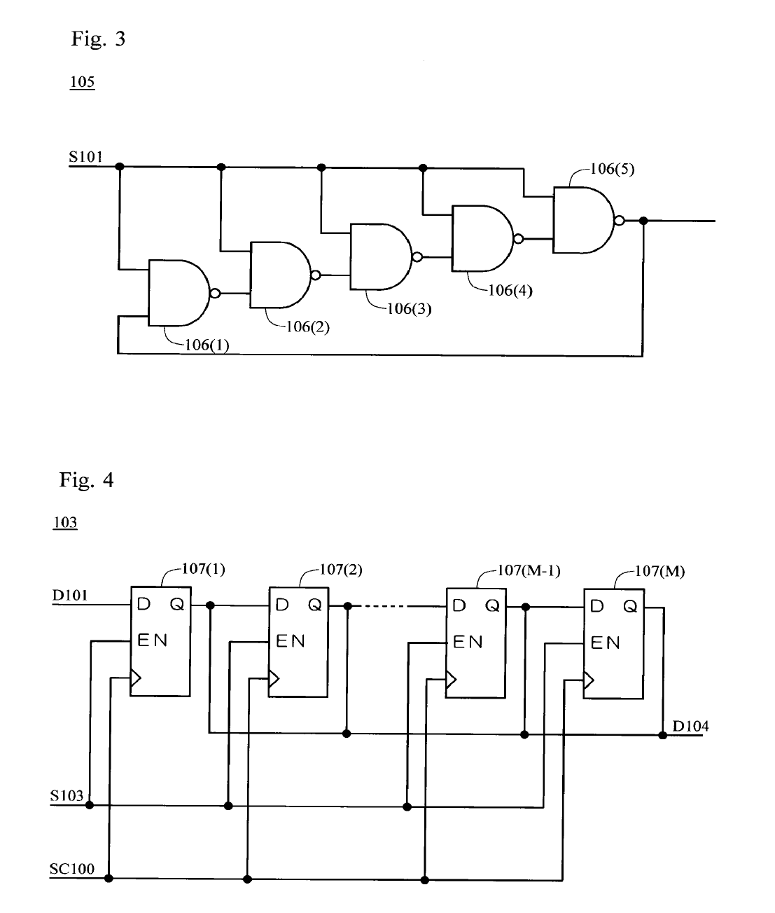

FIG. 3 is a diagram illustrating a configuration of one of the ring oscillators 105. The ring oscillator 105 includes an odd number of NAND circuits connected in serial. In the example illustrated in FIG. 3, the ring oscillator 105 includes five NAND circuits 106(1) to 106(5). One of the input terminals of each NAND circuit 106 receives the enabling signal S101. The other input terminal of the NAND circuit 106(1) in the first stage receives an output from the NAND circuit 106(5) in the last stage. The other input terminal of the NAND circuits 106(2) to 106(5) in the second and subsequent stages receives an output from the NAND circuit 106(1) to 106(4) in the preceding stage.

FIG. 4 is a diagram illustrating a configuration of the shift register 103. The shift register 103 includes multiple M number of flip-flops 107(1) to 107(M) connected in serial. Each flip-flop 107 receives a common input of the control signal S103 from the controller 104. Each flip-flop 107 also receives a common input of a system clock SC100.

The D terminal of the flip-flop 107(1) in the first stage receives the N-bit output value D101 from the oscillation circuit 102. The D terminal of the flip-flops 107(2) to 107(M) in the second and subsequent stages receives an output from the Q terminal of the flip-flops 107(1) to 107(M−1) in the preceding stage. The M number of flip-flops 107(1) to 107(M) are connected in serial, with N-bit outputs from each flip-flop 107 being arranged, so that the true random number D104 having N×M bits in total is output from the shift register 103.

Description is given below of an operation of the random number generation device 101 according to Embodiment 1-1 with reference to FIG. 1.

In a period when generation of the true random number D104 is not requested, enabling signals S101 and S102 are negated, by which operations of the oscillation circuit 102 and the controller 104 are suspended.

When generation of the true random number D104 is requested, the enabling signal S101 is firstly asserted. Upon assertion of the enabling signal S101, the oscillation circuit 102 starts an oscillation operation. Thus the oscillation circuit 102 outputs the output value D101.

Then the pseudo random number generator 111 performs initialization, employing the output value D101 from the oscillation circuit 102 as the seed, and then generates a pseudo random number D102 in accordance with a predetermined algorithm. The pseudo random number D102 generated by the pseudo random number generator 111 is input to one of the input terminals of the comparator 113.

Then the enabling signal S102 for instructing a start of the operation of the counter 112 is asserted, upon which the counter 112 starts a count operation of the system clock SC100 from a predetermined initial value (for example, “0”). The counter 112 increments a count value every time the system clock SC100 is input, and the count value D103 is input to the other input terminal of the comparator 113.

The comparator 113 sequentially compares the value of the pseudo random number D102 with the count value D103 from the counter 112. When the count operation of the counter 112 proceeds and the count value D103 matches the value of the pseudo random number D102, the control signal S103 is output to cause the shift register 103 to perform sampling.

Upon receipt of an input of the control signal S103 from the comparator 113, the shift register 103 samples the output value D101 that the oscillation circuit 102 outputs at that time. Referring to FIG. 4, the sampled output value D101 is input to and stored in the flip-flop 107(1) in the first stage.

The control signal S103 output from the comparator 113 is also input to the pseudo random number generator 111 and the counter 112.

Upon receipt of an input of the control signal S103, the pseudo random number generator 111 performs initialization, employing the output value D101 input from the oscillation circuit 102 at that time as the seed, and then generates a second pseudo random number D102. Upon receipt of an input of the control signal S103, the counter 112 resets the count value to the initial value and starts a second count operation. When the count value D103 in the second count operation matches the value of the second pseudo random number D102, the comparator 113 outputs a second control signal S103. Upon receipt of an input of the second control signal S103, the shift register 103 samples the output value D101 that the oscillation circuit 102 outputs at that time. Referring to FIG. 4, the sampled output value D101 is input to and stored in the flip-flop 107(1) in the first stage. The output value D101 stored in the flip-flop 107(1) in the first stage until then (the output value D101 sampled on the basis of the first control signal S103) is shifted from the flip-flop 107(1) in first stage to the flip-flop 107(2) in the second stage. Operations similar to the above are repeated M times, so that each of the M number of flip-flops 107(1) to 107(M) stores the output value D101. Then the N-bit output values D101 stored in the M number of flip-flops 107(1) to 107(M) are output from their Q terminals, with these M number of output values D101 being arranged, so that the true random number D104 having N×M bits in total is output from the shift register 103.

In the random number generation device 101 according to Embodiment 1-1, the controller 104 determines a sampling timing, by generating data in which values change irregularly, on the basis of the output value D101 from the oscillation circuit 102. Thus the controller 104 can irregularly vary a sampling timing, which in consequence enhances the trueness (impossibility of reproduction and impossibility of prediction) of the random number D104 generated by the shift register 103. Moreover, the output value D101 from the oscillation circuit 102 varies depending on environmental factors such as ambient temperature or humidity, and the sampling timing determined by the controller 104 varies accordingly, which in consequence enhances the trueness of the random number D104. Furthermore, in comparison with generating a sampling clock by dividing the system clock frequency, circuit design is facilitated by using one clock, and minute setting of a sampling timing is enabled without limitation to an integer multiple of the system clock, and thus the trueness of the random number D104 is enhanced more effectively.

In the random number generation device 101 according to Embodiment 1-1, the controller 104 includes the pseudo random number generator 111 that generates the pseudo random number D102, employing the output value D101 from the oscillation circuit 102 as a seed. Since the output value D101 from the oscillation circuit 102 changes every second, the pseudo random number D102 generated employing this value as a seed also changes every second. In consequence, as a value of this pseudo random number D102, data in which values change irregularly is effectively generated.

In the random number generation device 101 according to Embodiment 1-1, the controller 104 outputs the control signal S103 for causing the shift register 103 to perform sampling of the output value D101 from the oscillation circuit 102, when the number of counts of the system clock SC100 by the counter 112 matches the value of the pseudo random number D102 generated by the pseudo random number generator 111. The shift register 103 samples the output value D101 from the oscillation circuit 102 upon receipt of an input of the control signal S103, which enables the shift register 103 to generate the random number D104.

In the random number generation device 101 according to Embodiment 1-1, operations of the oscillation circuit 102 and the controller 104 are suspended in a period when generation of the random number D104 by the random number generation unit is not required. This effectively reduces power consumption.

### Embodiment 1-2

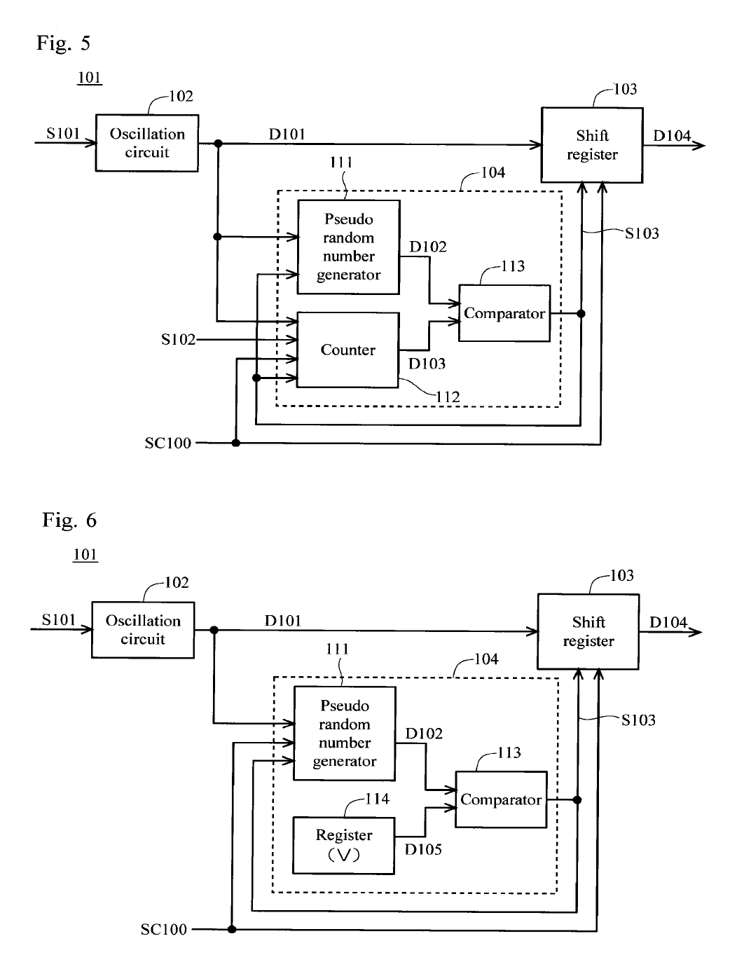

FIG. 5 is a diagram illustrating a configuration of a random number generation device 101 according to Embodiment 1-2 of the present disclosure. FIG. 5 illustrates a connection in the random number generation device 101 including an oscillation circuit 102, a shift register 103, and a controller 104. The controller 104 includes a pseudo random number generator 111, a counter 112, and a comparator 113.

Description is given below of an operation of the random number generation device 101 according to Embodiment 1-2 with reference to FIG. 5.

In a period when generation of the true random number D104 is not requested, enabling signals S101 and S102 are negated, by which operations of the oscillation circuit 102 and the controller 104 are suspended.

When generation of the true random number D104 is requested, the enabling signal S101 is firstly asserted. Upon assertion of the enabling signal S101, the oscillation circuit 102 starts an oscillation operation. Thus the oscillation circuit 102 outputs the output value D101.

Then the pseudo random number generator 111 performs initialization, employing the output value D101 from the oscillation circuit 102 as the seed, and then generates a pseudo random number D102 in accordance with a predetermined algorithm. The pseudo random number D102 generated by the pseudo random number generator 111 is input to one of the input terminals of the comparator 113.

The output value D101 from the oscillation circuit 102 is also input to the counter 112, and the counter 112 sets an initial value for count to the received output value D101.

Then the enabling signal S102 for instructing a start of the operation of the counter 112 is asserted, upon which the counter 112 starts a count operation of the system clock SC100 from the above initial value. The counter 112 increments a count value every time the system clock SC100 is input, and the count value D103 is input to the other input terminal of the comparator 113.

The comparator 113 sequentially compares the value of the pseudo random number D102 with the count value D103 from the counter 112. When the count operation of the counter 112 proceeds and the count value D103 matches the value of the pseudo random number D102, the control signal S103 is output to cause the shift register 103 to perform sampling.

Upon receipt of an input of the control signal S103 from the comparator 113, the shift register 103 samples the output value D101 that the oscillation circuit 102 outputs at that time.

The control signal S103 output from the comparator 113 is also input to the pseudo random number generator 111 and the counter 112.

Upon receipt of an input of the control signal S103, the pseudo random number generator 111 performs initialization, employing the output value D101 input from the oscillation circuit 102 at that time as the seed, and then generates a second pseudo random number D102. Upon receipt of an input of the control signal S103, the counter 112 sets a second initial value to the output value D101 input from the oscillation circuit 102 at that time. Then a second count operation is started from the second initial value. When the count value D103 in the second count operation matches the value of the pseudo random number D102, the comparator 113 outputs a second control signal S103. Upon receipt of an input of the second control signal S103, the shift register 103 samples the output value D101 that the oscillation circuit 102 outputs at that time. Operations similar to the above are repeated M times, so that each of the M number of flip-flops 107(1) to 107(M) stores the output value D101. Then the N-bit output values D101 stored in the M number of flip-flops 107(1) to 107(M) are output from their Q terminals, with these M number of output values D101 being arranged, so that the true random number D104 having N×M bits in total is output from the shift register 103.

In the random number generation device 101 according to Embodiment 1-2, the controller 104 outputs the control signal S103 for causing the shift register 103 to perform sampling of the output value D101 from the oscillation circuit 102, when the number of counts of the system clock SC100 by the counter 112 matches the value of the pseudo random number D102 generated by the pseudo random number generator 111. The shift register 103 samples the output value D101 from the oscillation circuit 102 upon receipt of an input of the control signal S103, which enables the shift register 103 to generate the random number D104. The counter 112 employs the output value D101 from the oscillation circuit 102 as an initial value. Since the output value D101 from the oscillation circuit 102 changes every second, the initial value of the counter 112 also changes every second. Even if an identical value of the pseudo random number D102 is employed, since the number of counts of the system clock SC100 that matches the value of the pseudo random number D102 varies, timing for the controller 104 to output the control signal S103 also varies, which in consequence enhances the trueness of the random number D104.

### Embodiment 1-3

FIG. 6 is a diagram illustrating a configuration of a random number generation device 101 according to Embodiment 1-3 of the present disclosure. FIG. 6 illustrates a connection in the random number generation device 101 including an oscillation circuit 102, a shift register 103, and a controller 104. The controller 104 includes a pseudo random number generator 111, a register 114, and a comparator 113.

Description is given below of an operation of the random number generation device 101 according to Embodiment 1-3 with reference to FIG. 6.

In a period when generation of the true random number D104 is not requested, enabling signals S101 and S102 are negated by which operations of the oscillation circuit 102 and the controller 104 are suspended.

When generation of the true random number D104 is requested, the enabling signal S101 is firstly asserted. Upon assertion of the enabling signal S101, the oscillation circuit 102 starts an oscillation operation. Thus the oscillation circuit 102 outputs the output value D101.

Then the pseudo random number generator 111 performs initialization, employing the output value D101 from the oscillation circuit 102 as the seed, and then generates a pseudo random number D102 in accordance with a predetermined algorithm. The pseudo random number generator 111 has an input of a system clock SC100. The pseudo random number generator 111 generates a new pseudo random number D102 in synchronization with the system clock SC100. The pseudo random number D102 generated by the pseudo random number generator 111 is input to one of the input terminals of the comparator 113.

The register 114 stores one or multiple predetermined values V preset in advance. The predetermined value V is input to the other input terminal of the comparator 113 as data D105.

The comparator 113 sequentially compares the value of the pseudo random number D102 with the predetermined value V. When the value of the pseudo random number D102 matches the predetermined value V, the control signal S103 is output to cause the shift register 103 to perform sampling.

Upon receipt of an input of the control signal S103 from the comparator 113, the shift register 103 samples the output value D101 that the oscillation circuit 102 outputs at that time.

The control signal S103 output from the comparator 113 is also input to the pseudo random number generator 111.

Upon receipt of an input of the control signal S103, the pseudo random number generator 111 performs initialization, employing the output value D101 input from the oscillation circuit 102 at that time as the seed, and then generates a pseudo random number D102 in synchronization with the system clock SC100 in a similar way to the above. The comparator 113 sequentially compares the value of the pseudo random number D102 with the predetermined value V. When the value of the pseudo random number D102 matches the predetermined value V, the second control signal S103 is output. Upon receipt of an input of the second control signal S103, the shift register 103 samples the output value D101 that the oscillation circuit 102 outputs at that time. Operations similar to the above are repeated M times, so that each of the M number of flip-flops 107(1) to 107(M) stores the output value D101. Then the N-bit output values D101 stored in the M number of flip-flops 107(1) to 107(M) are output from their Q terminals, with these M number of output values D101 being arranged, so that the true random number D104 having N×M bits in total is output from the shift register 103.

In the random number generation device 101 according to Embodiment 1-3, the controller 104 outputs the control signal S103 for causing the shift register 103 to perform sampling of the output value D101 from the oscillation circuit 102, when the value of the pseudo random number D102 generated by the pseudo random number generator 111 matches the preset predetermined value V. The shift register 103 samples the output value D101 from the oscillation circuit 102 upon receipt of an input of the control signal S103, which enables the shift register 103 to generate the random number D104. Without the counter 112 for counting the system clock SC100, a circuit configuration is simplified.

### Embodiment 1-4

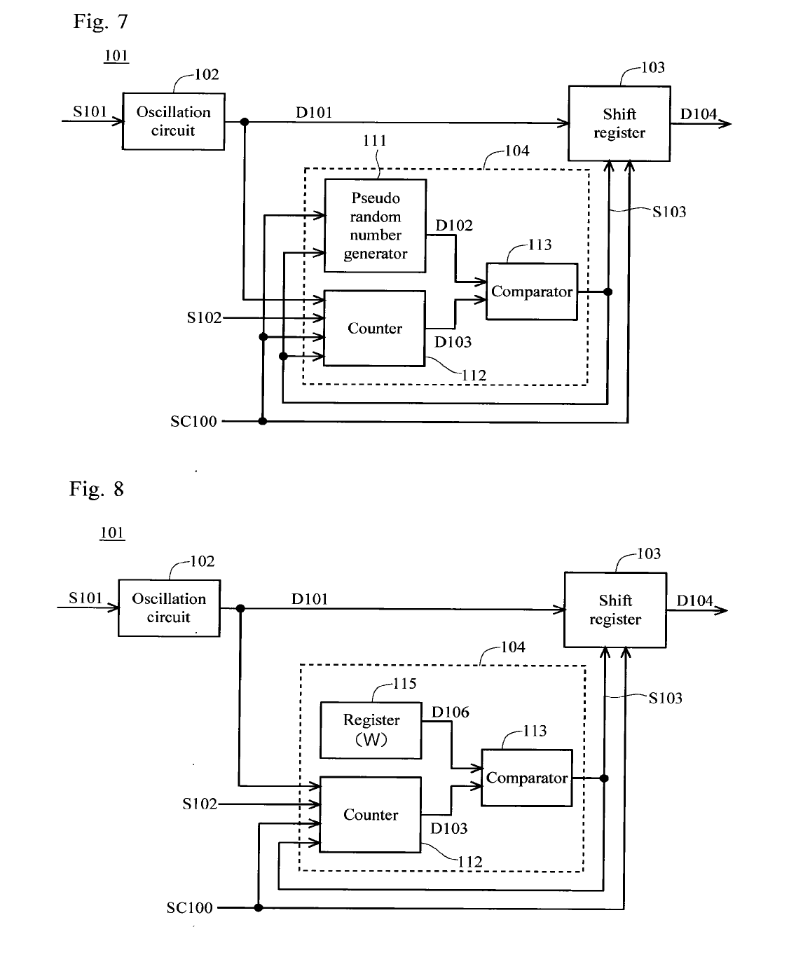

FIG. 7 is a diagram illustrating a configuration of a random number generation device 101 according to Embodiment 1-4 of the present disclosure. FIG. 7 illustrates a connection in the random number generation device 101 including an oscillation circuit 102, a shift register 103, and a controller 104. The controller 104 includes a pseudo random number generator 111, a counter 112, and a comparator 113.

Description is given below of an operation of the random number generation device 101 according to Embodiment 1-4 with reference to FIG. 7.

In a period when generation of the true random number D104 is not requested, enabling signals S101 and S102 are negated, by which operations of the oscillation circuit 102 and the controller 104 are suspended.

When generation of the true random number D104 is requested, the enabling signal S101 is firstly asserted. Upon assertion of the enabling signal S101, the oscillation circuit 102 starts an oscillation operation. Thus the oscillation circuit 102 outputs the output value D101.

Then the pseudo random number generator 111 performs initialization, employing a predetermined value preset in advance as the seed, and generates a pseudo random number D102 in accordance with a predetermined algorithm. The pseudo random number D102 generated by the pseudo random number generator 111 is input to one of the input terminals of the comparator 113.

The output value D101 from the oscillation circuit 102 is input to the counter 112, and the counter 112 sets an initial value for count to the received output value D101.

Then the enabling signal S102 for instructing a start of the operation of the counter 112 is asserted, upon which the counter 112 starts a count operation of the system clock SC100 from the above initial value. The counter 112 increments a count value every time the system clock SC100 is input, and the count value D103 is input to the other input terminal of the comparator 113.

The comparator 113 sequentially compares the value of the pseudo random number D102 with the count value D103 from the counter 112. When the count operation of the counter 112 proceeds and the count value D103 matches the value of the pseudo random number D102, the control signal S103 is output to cause the shift register 103 to perform sampling.

Upon receipt of an input of the control signal S103 from the comparator 113, the shift register 103 samples the output value D101 that the oscillation circuit 102 outputs at that time.

The control signal S103 output from the comparator 113 is also input to the pseudo random number generator 111 and the counter 112.

Upon receipt of an input of the control signal S103, the pseudo random number generator 111 generates a second pseudo random number D102. Upon receipt of an input of the control signal S103, the counter 112 sets a second initial value to the output value D101 input from the oscillation circuit 102 at that time. Then a second count operation is started from the second initial value. When the count value D103 in the second count operation matches the value of the pseudo random number D102, the comparator 113 outputs a second control signal S103. Upon receipt of an input of the second control signal S103, the shift register 103 samples the output value D101 that the oscillation circuit 102 outputs at that time. Operations similar to the above are repeated M times, so that each of the M number of flip-flops 107(1) to 107(M) stores the output value D101. Then the N-bit output values D101 stored in the M number of flip-flops 107(1) to 107(M) are output from their Q terminals, with these M number of output values D101 being arranged, so that the true random number D104 having N×M bits in total is output from the shift register 103.

In the random number generation device 101 according to Embodiment 1-4, the controller 104 includes a counter 112 for counting the system clock SC100, employing the output value D101 from the oscillation circuit 102 as an initial value. Since the output value D101 from the oscillation circuit 102 changes every second, the initial value of the counter 112 also changes every second. In consequence, as the number of counts from an initial value to a target value (value of the pseudo random number D102) of the system clock SC100 by the counter 112, data in which values change irregularly is effectively generated.

The controller 104 outputs the control signal S103 for causing the shift register 103 to perform sampling of the output value D101 from the oscillation circuit 102, when the number of counts of the system clock SC100 by the counter 112 matches the value of the pseudo random number D102 generated by the pseudo random number generator 111. The shift register 103 samples the output value D101 from the oscillation circuit 102 upon receipt of an input of the control signal S103, which enables the shift register 103 to generate the random number D104. The value of the pseudo random number D102 generated by the pseudo random number generator 111 (that is, the target value of the counter 112) changes every second. Even if an identical initial value of the counter 112 is employed, since the number of counts of the system clock SC100 that matches the value of the pseudo random number D102 varies, timing for the controller 104 to output the control signal S103 also varies, which in consequence enhances the trueness of the random number D104.

### Embodiment 1-5

FIG. 8 is a diagram illustrating a configuration of a random number generation device 101 according to Embodiment 1-5 of the present disclosure. FIG. 8 illustrates a connection in the random number generation device 101 including an oscillation circuit 102, a shift register 103, and a controller 104. The controller 104 includes a register 115, a counter 112, and a comparator 113.

Description is given below of an operation of the random number generation device 101 according to Embodiment 1-5 with reference to FIG. 8.

In a period when generation of the true random number D104 is not requested, enabling signals S101 and S102 are negated, by which operations of the oscillation circuit 102 and the controller 104 are suspended.

When generation of the true random number D104 is requested, the enabling signal S101 is firstly asserted. Upon assertion of the enabling signal S101, the oscillation circuit 102 starts an oscillation operation. Thus the oscillation circuit 102 outputs the output value D101.

The register 115 stores one or multiple predetermined value W preset in advance. The predetermined value W is input to one of the input terminals of the comparator 113 as data D106.

The output value D101 from the oscillation circuit 102 is input to the counter 112, and the counter 112 sets an initial value for count to the received output value D101.

Then the enabling signal S102 for instructing a start of the operation of the counter 112 is asserted, upon which the counter 112 starts a count operation of the system clock SC100 from the above initial value. The counter 112 increments a count value every time the system clock SC100 is input, and the count value D103 is input to the other input terminal of the comparator 113.

The comparator 113 sequentially compares the predetermined value W with the count value D103 of the counter 112. When the count operation of the counter 112 proceeds and the count value D103 matches the predetermined value W, the control signal S103 is output to cause the shift register 103 to perform sampling.

Upon receipt of an input of the control signal S103 from the comparator 113, the shift register 103 samples the output value D101 that the oscillation circuit 102 outputs at that time.

The control signal S103 output from the comparator 113 is also input to the counter 112.

Upon receipt of an input of the control signal S103, the counter 112 sets a second initial value to the output value D101 input from the oscillation circuit 102 at that time. Then a second count operation is started from the second initial value. When the count value D103 in the second count operation matches the predetermined value W, the comparator 113 outputs a second control signal S103. Upon receipt of an input of the second control signal S103, the shift register 103 samples the output value D101 that the oscillation circuit 102 outputs at that time. Operations similar to the above are repeated M times, so that each of the M number of flip-flops 107(1) to 107(M) stores the output value D101. Then the N-bit output values D101 stored in the M number of flip-flops 107(1) to 107(M) are output from their Q terminals, with these M number of output values D101 being arranged, so that the true random number D104 having N×M bits in total is output from the shift register 103.

In the random number generation device 101 according to Embodiment 1-5, the controller 104 outputs the control signal S103 for causing the shift register 103 to perform sampling of the output value D101 from the oscillation circuit 102, when the number of counts of the system clock SC100 by the counter 112 matches the preset predetermined value W. The shift register 103 samples the output value D101 from the oscillation circuit 102 upon receipt of an input of the control signal S103, which enables the shift register 103 to generate the random number D104. Since the target value of the counter 112 is fixed at the predetermined value W, without the pseudo random number generator 111 for generating the target value, a circuit configuration is simplified.

### Embodiment 2-1

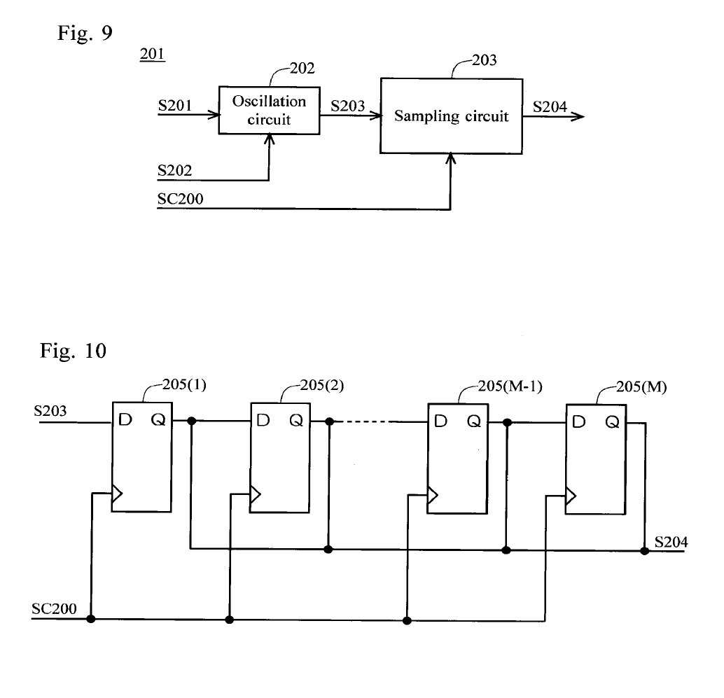

FIG. 9 is a diagram illustrating a configuration of a random number generation device 201 according to Embodiment 2-1 of the present disclosure. As illustrated in FIG. 9, the random number generation device 201 includes an oscillation circuit 202 and a sampling circuit 203 in a stage subsequent to the oscillation circuit 202.

The oscillation circuit 202 outputs an output value S203 having alternating 0 and 1 of two-valued logic. The sampling circuit 203 functions as a random number generation circuit operable to sample the output value S203 from the oscillation circuit 202 on the basis of a sampling clock SC200, so as to generate a true random number S204.

FIG. 10 is a diagram illustrating a configuration of the sampling circuit 203. The sampling circuit 203 includes multiple M number of flip-flops 205(1) to 205(M) connected in serial. Each flip-flop 205 receives a common input of the sampling clock SC200.

The D terminal of the flip-flop 205(1) in the first stage receives the output value S203 from the oscillation circuit 202. The D terminal of the flip-flops 205(2) to 205(M) in the second and subsequent stages receives an output from the Q terminal of the flip-flops 205(1) to 205(M−1) in the preceding stage. The M number of flip-flops 205(1) to 205(M) are connected in serial, with outputs from each flip-flop 205 being arranged, so that the true random number S204 having M bits in total is output from the sampling circuit 203.

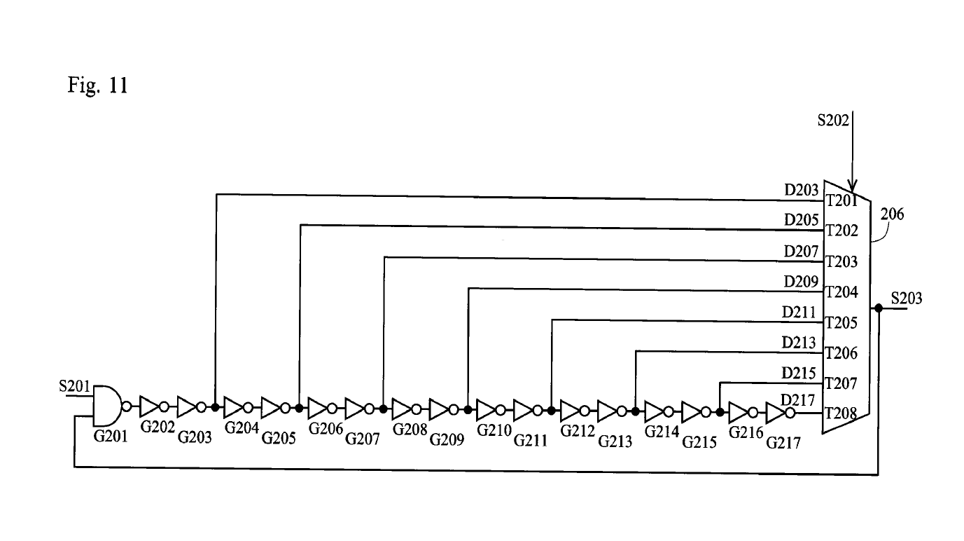

FIG. 11 is a diagram illustrating a configuration of the oscillation circuit 202. The oscillation circuit 202 includes multiple odd number of logical gates connected in serial. In the example in FIG. 11, the oscillation circuit 202 includes 17 logical gates G201 to G217. The logical gate G201 in the first stage employs a NAND circuit, while the logical gates G202 to G217 in the second and subsequent stages employ an inverter circuit.

A selector 206 includes multiple input terminals. In the example illustrated in FIG. 11, the selector 206 includes eight input terminals T201 to T208. The input terminal T201 receives an output value D203 from the logical gate G203 in the third stage. Similarly, the input terminal T202 receives an output value D205 from the logical gate G205 in the fifth stage, the input terminal T203 receives an output value D207 from the logical gate G207 in the seventh stage, the input terminal T204 receives an output value D209 from the logical gate G209 in the ninth stage, the input terminal T205 receives an output value D211 from the logical gate G211 in the 11th stage, the input terminal T206 receives an output value D213 from the logical gate G213 in the 13th stage, the input terminal T207 receives an output value D215 from the logical gate G215 in the 15th stage, and the input terminal T208 receives an output value D217 from the logical gate G217 in the last stage.

The selector 206 selects one of the output values D203, D205, D207, D209, D211, D213, D215, and D217 on the basis of a selection signal S202 input from an external device of the random number generation device 201, and outputs the selected output value as an output value S203. In other words, the selector 206 functions as a setting unit which may include suitable logic, circuitry, interfaces and/or code that may be operable to variably set an oscillation frequency of the oscillation circuit 202. For example, if the output value D203 is selected, the oscillation frequency of the oscillation circuit 202 is set to an oscillation frequency equivalent to that of a ring oscillator having 3 stages, and if the output value D205 is selected, the oscillation frequency of the oscillation circuit 202 is set to an oscillation frequency equivalent to that of a ring oscillator having 5 stages.

One of the input terminals of the logical gate G201 in the first stage receives an enabling signal S201 for instructing a start of the operation of the oscillation circuit 202. The other input terminal of the logical gate G201 receives the output value S203 from the selector 206. The logical gates G202 to G217 in the second and subsequent stages receive an output from the logical gates G201 to G216 in the preceding stages.

Description is given below of an operation of the random number generation device 201 according to Embodiment 2-1 with reference to FIGS. 9 to 11. The operations below are performed, for example, in an inspection before shipment of a product.

In a period when generation of the true random number S204 is not requested, the enabling signal S201 is negated, by which an operation of the oscillation circuit 202 is suspended.

When generation of the true random number S204 is requested, the enabling signal S201 is asserted. Upon assertion of the enabling signal S201, the oscillation circuit 202 starts an oscillation operation. Thus the oscillation circuit 202 outputs the output values D203, D205, D207, D209, D211, D213, D215, and D217.

The selector 206 selects one of the output values D203, D205, D207, D209, D211, D213, D215, and D217 on the basis of the selection signal S202, and outputs the selected output value as the output value S203. The output value S203 is input to the sampling circuit 203. Here, the selector 206 selects the input terminal T201 (output value D203) by way of an non-limiting example. In this example, the oscillation frequency of the oscillation circuit 202 is set to an oscillation frequency equivalent to that of a ring oscillator having 3 stages.

The sampling circuit 203 samples the output value S203 in synchronization with the sampling clock SC200. Referring to FIG. 10, the sampled output value S203 is input to and stored in the flip-flop 205(1) in the first stage. Upon receipt of an input of a next sampling clock SC200, the sampling circuit 203 samples the output value S203 that the oscillation circuit 202 output at that time. The sampled output value S203 is input to and stored in the flip-flop 205(1) in the first stage. The output value S203 stored in the flip-flop 205(1) in the first stage until then (the output value S203 sampled on the basis of the previous sampling clock SC200) is shifted from the flip-flop 205(1) in the first stage to the flip-flop 205(2) in the second stage. Operations similar to the above are repeated M times, so that each of the M number of flip-flops 205(1) to 205(M) stores the output value S203. Then the output values S203 stored in the flip-flops 205(1) to 205(M) are output from their Q terminals, with these M number of output values S203 being arranged, so that the random number S204 having M bits in total is output from the sampling circuit 203.

Then trueness (impossibility of reproduction and impossibility of prediction) of the generated random number S204 is evaluated. If the trueness of the random number S204 is lower than a required value, the external device inputs the selection signal S202 to the selector 206, so that an input terminal other than the currently-selected input terminal T201, (for example, the input terminal T202) is selected. In other words, oscillation frequency of the oscillation circuit 202 is changed. Then the random number S204 is generated in a similar way to the above, and the trueness of the generated random number S204 is evaluated again. Change of the oscillation frequency by the selector 206 and evaluation of the generated random number S204 are repeated until a random number S204 having a trueness higher than the required value is obtained.

In the random number generation device 201 according to Embodiment 2-1, the selector 206 (setting unit) variably sets the oscillation frequency of the oscillation circuit 202. If the random number S204 shows low trueness due to properties of the oscillation circuit 202, a different frequency that leads to the random number S204 with high trueness is employed, so that generation of the random number S204 having a high trueness is enabled irrespective of properties of the oscillation circuit 202. If the random number S204 is not generated with an oscillation frequency set at shipment due to a failure or the like in a certain logical gate, another frequency is employed so as to generate a desired random number S204, which in consequence improves a reliability of the device.

In the random number generation device 201 according to Embodiment 2-1, the selector 206 sets the oscillation frequency of the oscillation circuit 202 on the basis of the selection signal S202 that is externally input. If the random number S204 shows low trueness at an inspection before shipment of a product, a frequency that would lead to a random number S204 with high trueness is searched and this frequency is employed with the selection signal S202, so that a product that will generate a random number S204 with high trueness is shipped. In consequence, an improvement in yield is expected.

In the random number generation device 201 according to Embodiment 2-1, the oscillation circuit 202 includes the multiple odd number of logical gates G201 to G217 connected in serial. The selector 206 includes the multiple input terminals T201 to T208. The input terminals T201 to T208 of the selector 206 receive an output value from a different logical gate among all the logical gates G201 to G217. This achieves the oscillation circuit 202 capable of variably setting an oscillation frequency with simple configuration at low cost.

### Embodiment 2-2

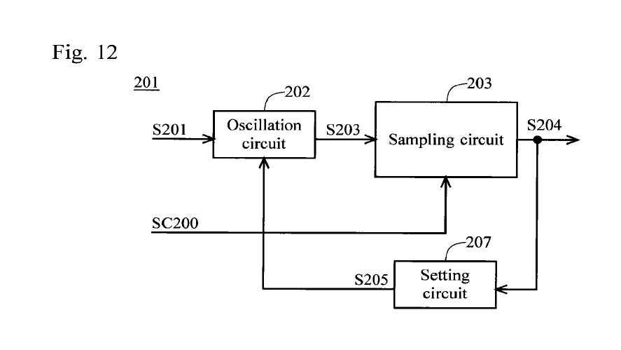

FIG. 12 is a diagram illustrating a configuration of a random number generation device 201 according to Embodiment 2-2 of the present disclosure. FIG. 12 illustrates a connection in the random number generation device 201 including an oscillation circuit 202, a sampling circuit 203, and a setting circuit 207. The setting circuit 207 generates a selection signal S205 on the basis of a true random number S204 generated by the sampling circuit 203. The setting circuit 207 outputs the selection signal S205 for every random number S204 output from the sampling circuit 203.

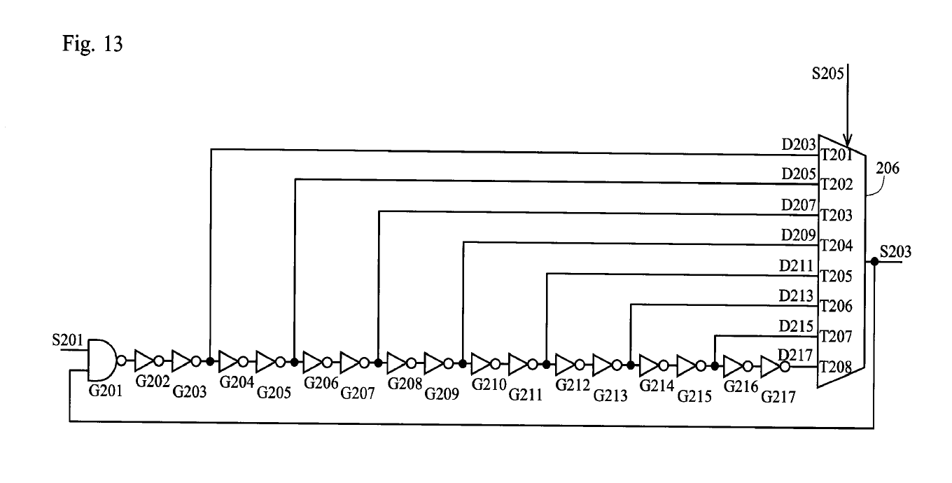

FIG. 13 is a diagram illustrating a configuration of the oscillation circuit 202. The selector 206 selects one of the output values D203, D205, D207, D209, D211, D213, D215, and D217, on the basis of the selection signal S205 input from the setting circuit 207, and outputs the selected output value as an output value S203.

Description is given below of an operation of the random number generation device 201 according to Embodiment 2-2 with reference to FIGS. 12 and 13. The operations below are performed, for example, during an actual operation after shipment of a product.

In a period when generation of the true random number S204 is not requested, the enabling signal S201 is negated, by which an operation of the oscillation circuit 202 is suspend.

When generation of the true random number S204 is requested, the enabling signal S201 is asserted. Upon assertion of the enabling signal S201, the oscillation circuit 202 starts an oscillation operation. Thus the oscillation circuit 202 outputs the output values D203, D205, D207, D209, D211, D213, D215, and D217.

The selector 206 selects one of the output values D203, D205, D207, D209, D211, D213, D215, and D217 on the basis of the selection signal S205, and outputs the selected output value as the output value S203. The output value S203 is input to the sampling circuit 203.

The sampling circuit 203 samples the output value S203 in synchronization with the sampling clock SC200, so as to generate and output the random number S204.

The setting circuit 207 generates the selection signal S205 on the basis of the random number S204. In the example of the present embodiment, the selector 206 includes eight input terminals T201 to T208. Since the required bit width of the selection signal S205 is 3 bits, the setting circuit 207 extracts certain 3 bits (for example, upper 3 bits or lower 3 bits) from the M-bit random number S204, so as to generate a 3-bit selection signal S205. Alternatively, the 3-bit selection signal S205 may be generated from the random number S204 by an arithmetic operation such as an exclusive or.

The selector 206 selects one of the output values D203, D205, D207, D209, D211, D213, D215, and D217 on the basis of the selection signal S205 input from the setting circuit 207, and outputs the selected output value as an output value S203. Operations similar to the above are repeated from then on. Every time the sampling circuit 203 generates the random number S204, the selector 206 changes the oscillation frequency of the oscillation circuit 202 on the basis of the random number S204.

In the random number generation device 201 according to Embodiment 2-2, the selector 206 (setting unit) sets the oscillation frequency of the oscillation circuit 202 on the basis of the random number S204 generated by the sampling circuit 203. Since the oscillation frequency of the oscillation circuit 202 irregularly varies corresponding to the random number S204 generated by the sampling circuit 203, the trueness of the generated random number S204 is enhanced.

In the random number generation device 201 according to Embodiment 2-2, every time the random number S204 is output from the sampling circuit 203, the selector 206 sets the oscillation frequency of the oscillation circuit 202 on the basis of the random number S204. Since the oscillation frequency of the oscillation circuit 202 varies every time the sampling circuit 203 outputs the random number S204, the trueness of the generated random number S204 is further enhanced.

### Embodiment 2-3

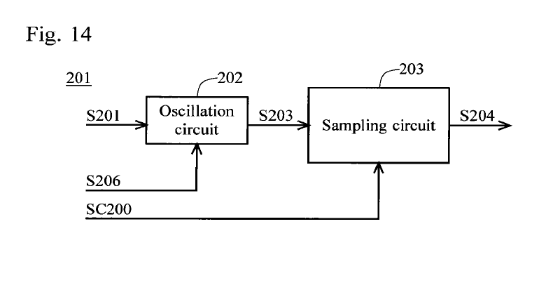

FIG. 14 is a diagram illustrating a configuration of a random number generation device 201 according to Embodiment 2-3 of the present disclosure. As illustrated in FIG. 14, the random number generation device 201 includes an oscillation circuit 202 and a sampling circuit 203 in a stage subsequent to the oscillation circuit 202.

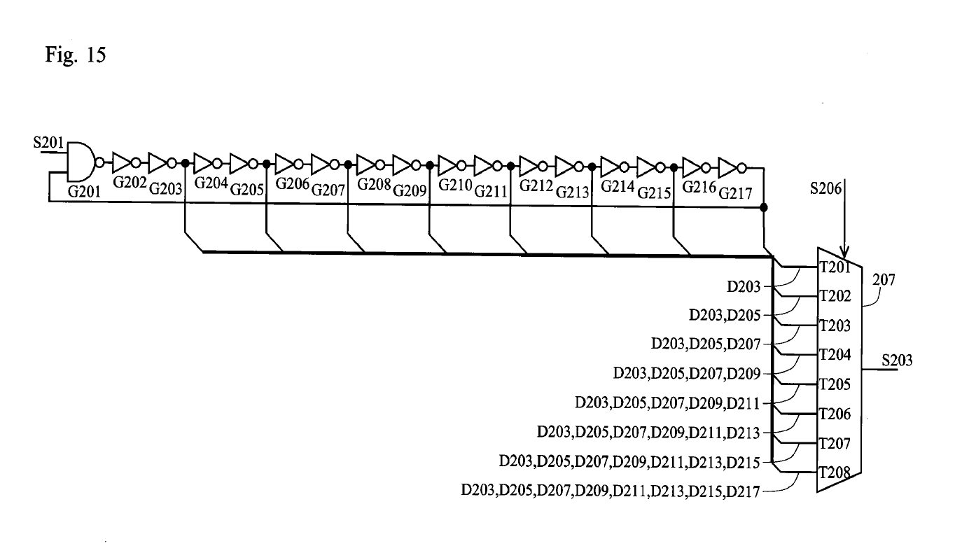

FIG. 15 is a diagram illustrating a configuration of the oscillation circuit 202. The oscillation circuit 202 includes multiple odd number of logical gates connected in serial. In the example in FIG. 15, the oscillation circuit 202 includes 17 logical gates G201 to G217. The logical gate G201 in the first stage employs a NAND circuit, while the logical gates G202 to G217 in the second and subsequent stages employ an inverter circuit.

A selector 207 includes multiple input terminals. In the example in FIG. 15, the selector 207 includes eight input terminals T201 to T208. The input terminal T201 receives an output value D203 from the logical gate G203 in the third stage. The input terminal T202 receives the output value D203 and an output value D205 from the logical gate G205 in the fifth stage. The input terminal T203 receives the output values D203 and D205 and an output value D207 from the logical gate G207 in the seventh stage. The input terminal T204 receives the output values D203, D205, and D207, and an output value D209 from the logical gate G209 in the ninth stage. The input terminal T205 receives the output values D203, D205, D207, and D209 and an output value D211 from the logical gate G211 in the 11th stage. The input terminal T206 receives the output values D203, D205, D207, D209, and D211 and an output value D213 from the logical gate G213 in the 13th stage. The input terminal T207 receives the output values D203, D205, D207, D209, D211, and D213 and an output value D215 from the logical gate G215 in the 15th stage. The input terminal T208 receives the output values D203, D205, D207, D209, D211, D213, and D215 and an output value D217 from the logical gate G217 in the last stage.

The selector 207 selects one of the input terminals T201 to T208 on the basis of a selection signal S206 input from an external device of the random number generation device 201, and outputs an output value in the selected input terminal as an output value S203. In other words, the selector 207 functions as a setting unit which may include suitable logic, circuitry, interfaces and/or code that may be operable to variably set an effective bus width of the output value S203. For example, if the input terminal T201 is selected, the effective bus width of the output value S203 is set to 1 bit, and if the input terminal T202 is selected, the effective bus width of the output value S203 is set to 2 bits.

One of the input terminals of the logical gate G201 in the first stage receives an enabling signal S201 for instructing a start of the operation of the oscillation circuit 202. The other input terminal of the logical gate G201 receives the output value D217 from the logical gate G217 in the last stage. The logical gates G202 to G217 in the second and subsequent stages receive an output from the logical gates G201 to G216 in the preceding stages.

Description is given below of an operation of the random number generation device 201 according to Embodiment 2-3 with reference to FIGS. 14 and 15. The operations below are performed, for example, before shipment of a product, or during an actual operation after shipment.

The effective bus width of the output value S203 is set with the selection signal S206. For example, the effective bus width of the output value S203 is set to a bus width that is neither excessive nor deficient for a required bus width of the external device in a subsequent stage that obtains the random number S204.

When generation of the true random number S204 is requested, the enabling signal S201 is asserted. Upon assertion of the enabling signal S201, the oscillation circuit 202 starts an oscillation operation. Thus the oscillation circuit 202 outputs the output values D203, D205, D207, D209, D211, D213, D215, and D217.

The selector 207 selects one of the input terminals T201 to T208 on the basis of the selection signal S206, and outputs the output value in the selected input terminal as an output value S203.

The sampling circuit 203 samples the output value S203 in synchronization with the sampling clock SC200, so as to generate and output the random number S204.

In the random number generation device 201 according to Embodiment 2-3, the selector 207 (setting unit) variably sets the effective bus width of the output value S203 of the selector 207 on the basis of the selection signal S206 that is externally input. Thus the selector 207 outputs the output value S203 having an effective bus width that is neither excessive nor deficient for a required bus width of the external device in a subsequent stage that obtains the random number S204, and the sampling circuit 203 samples the output value S203, so that the random number S204 having a required bus width is efficiently generated in the sampling circuit 203. In consequence, efficiency in sampling in the sampling circuit 203 is improved. Moreover, the selector 207 outputs the output value S203 having a minimum necessary effective bus width, so that power consumption is effectively reduced and malfunction caused by, for example, switching noise of clocks is suppressed.

In the random number generation device 201 according to Embodiment 2-3, the oscillation circuit 202 includes multiple odd number of logical gates G201 to G217 connected in serial, and the selector 207 includes multiple input terminals T201 to T208. The input terminals T201 to T208 of the selector 207 receive an output value from a different number of logical gates among all the logical gates G201 to G217. This achieves the oscillation circuit 202 capable of variably setting an effective bus width of the output value S203 with simple configuration at low cost.

### Embodiment 2-4

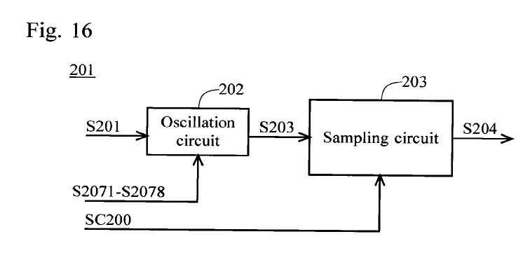

FIG. 16 is a diagram illustrating a configuration of a random number generation device 201 according to Embodiment 2-4 of the present disclosure. As illustrated in FIG. 16, the random number generation device 201 includes an oscillation circuit 202 and a sampling circuit 203 in a stage subsequent to the oscillation circuit 202.

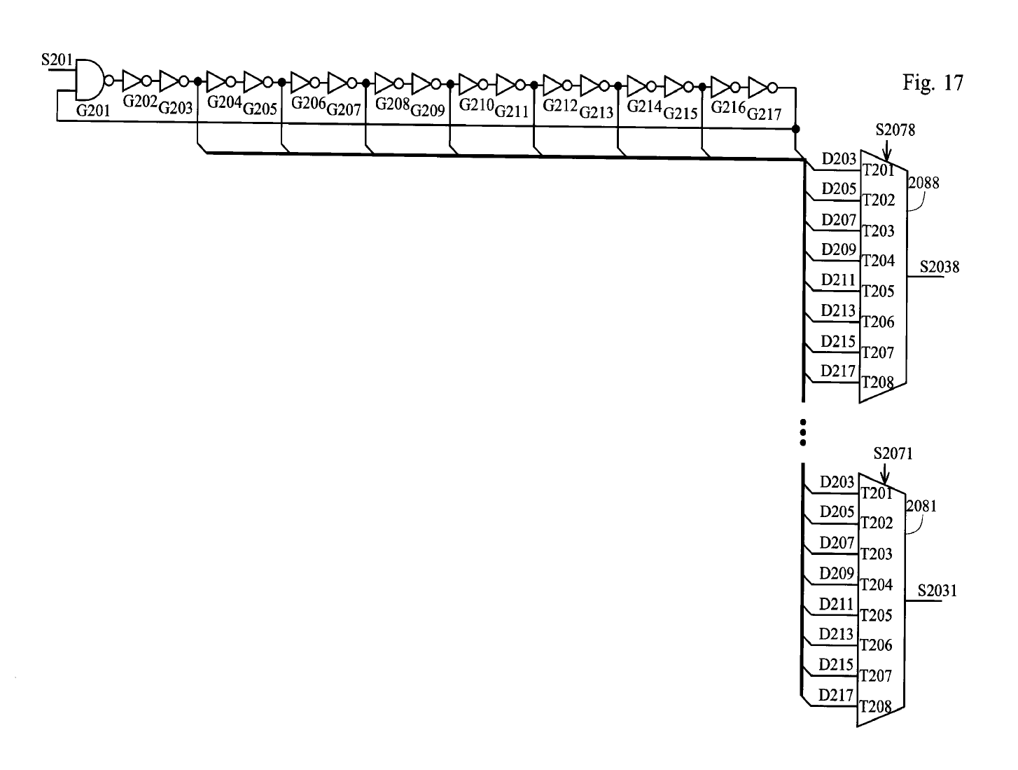

FIG. 17 is a diagram illustrating a configuration of the oscillation circuit 202. The oscillation circuit 202 includes multiple odd number of logical gates connected in serial. In the example in FIG. 17, the oscillation circuit 202 includes 17 logical gates G201 to G217. The logical gate G201 in the first stage employs a NAND circuit, while the logical gates G202 to G217 in the second and subsequent stages employ an inverter circuit.

A selector 208 is provided corresponding to each bit of the bus width N of the output value S203. In the example of the present embodiment, the bus width of the output value S203 is 8 bits, and thus eight selectors 2081 to 2088 are provided.

Each selector 208 includes multiple input terminals. In the example in FIG. 17, the selector 208 includes eight input terminals T201 to T208. The input terminal T201 receives an output value D203 from the logical gate G203 in the third stage. Similarly, the input terminal T202 receives an output value D205 from the logical gate G205 in the fifth stage, the input terminal T203 receives an output value D207 from the logical gate G207 in the seventh stage, the input terminal T204 receives an output value D209 from the logical gate G209 in the ninth stage, the input terminal T205 receives an output value D211 from the logical gate G211 in the 11th stage, the input terminal T206 receives an output value D213 from the logical gate G213 in the 13th stage, the input terminal T207 receives an output value D215 from the logical gate G215 in the 15th stage, and the input terminal T208 receives an output value D217 from the logical gate G217 in the last stage.

The selector 208 selects one of the input terminals T201 to T208 on the basis of selection signals S207 (S2071 to S2078) input from an external device of the random number generation device 201, and outputs the output value in the selected input terminal as output values S203 (S2031 to S2038). In other words, the selector 208 functions as a setting unit which may include suitable logic, circuitry, interfaces and/or code that may be operable to variably set an output bit position from the oscillation circuit 202 in each bit of the N-bit output value S203. For example, if the input terminal T201 is selected in the selector 2081, the output bit position is set to the logical gate G203, and thus the phase of the output value S2031 corresponds to a phase delayed by three logical gates. If the input terminal T202 is selected in the selector 2081, the output bit position is set to the logical gate G205, and thus the phase of the output value S2031 corresponds to a phase delayed by five logical gates.

One of the input terminals of the logical gate G201 in the first stage receives an enabling signal S201 for instructing a start of the operation of the oscillation circuit 202. The other input terminal of the logical gate G201 receives the output value D217 from the logical gate G217 in the last stage. The logical gates G202 to G217 in the second and subsequent stages receive an output from the logical gates G201 to G216 in the preceding stages.

Description is given below of an operation of the random number generation device 201 according to Embodiment 2-4 with reference to FIGS. 16 and 17. The operations below are performed, for example, before shipment of a product, or during an actual operation after shipment.

The frequency of each bit in the N-bit output value S203 is set with the selection signals S2071 to S2078. For example, if different frequencies among all bits (S2031 to S2038) of the output value S203 are desired, the selection signals S2071 to S2078 are set so that the selectors 2081 to 2088 select different input terminals T201 to T208.

When generation of the true random number S204 is requested, the enabling signal S201 is asserted. Upon assertion of the enabling signal S201, the oscillation circuit 202 starts an oscillation operation. Thus the oscillation circuit 202 outputs the output values D203, D205, D207, D209, D211, D213, D215, and D217.

The selectors 2081 to 2088 select one of the input terminals T201 to T208 on the basis of the selection signals S2071 to S2078, and output the output value in the selected input terminal as output values S2031 to S2038.

The sampling circuit 203 samples the output values S2031 to S2038 in synchronization with the sampling clock SC200, so as to generate and output the random number S204.

In the random number generation device 201 according Embodiment 2-4, the selector 208 (setting unit) generates the output value S203 having a multiple N-bit bus width on the basis of the output values D203, D205, D207, D209, D211, D213, D215, and D217 from the oscillation circuit 202. The sampling circuit 203 generates the random number S204 by sampling the output value S203 from the selector 208. Since the random number S204 having a bus width of multiple bits is generated by one oscillation circuit 202, a circuit size is reduced, in comparison with using multiple oscillation circuits. The selector 208 variably sets an output bit position from the oscillation circuit 202 in each bit of the N-bit output value S203, on the basis of the selection signal S207 that is externally input. Since each bit of the N-bit output value S203 can be in a different phase, the trueness of a generated random number S204 is enhanced.

In the random number generation device 201 according to Embodiment 2-4, the oscillation circuit 202 includes multiple odd number of logical gates G201 to G217 connected in serial. The selectors 2081 to 2088 respectively corresponding to each bit of the N-bit output value S203 includes multiple input terminals T201 to T208. The input terminals T201 to T208 of the selector 208 receive an output value from N number of different logical gates among all logical gates G201 to G217. This achieves the oscillation circuit 202 capable of variably setting an output bit position with simple configuration at low cost.

### Modification

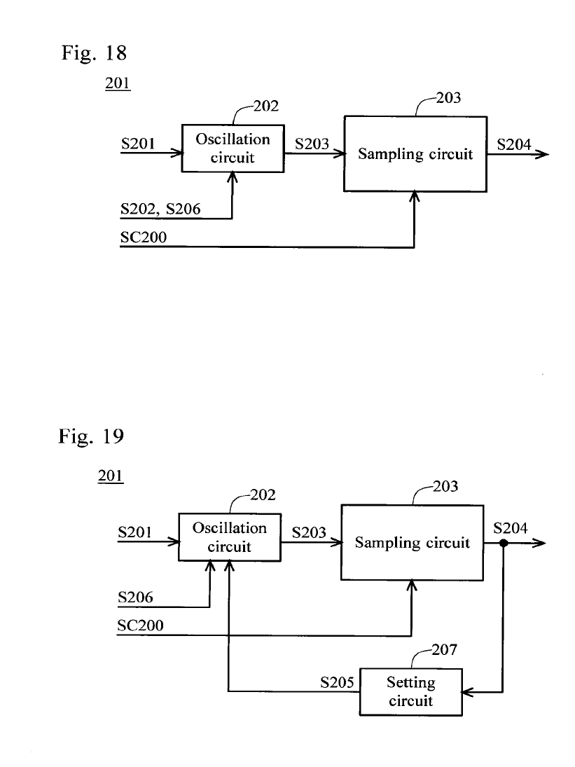

FIG. 18 is a diagram illustrating a configuration of a first modification of the random number generation device 201. The present modification of the random number generation device 201 employs a combination of Embodiment 2-1 (FIG. 9) and Embodiment 2-3 (FIG. 14). An oscillation frequency of the oscillation circuit 202 is variably set with the selection signal S202 and an effective bus width of the output value S203 is variably set with the selection signal S206.

FIG. 19 is a diagram illustrating a configuration of a second modification of the random number generation device 201. The present modification of the random number generation device 201 employs a combination of Embodiment 2-2 (FIG. 12) and Embodiment 2-3 (FIG. 14). An oscillation frequency of the oscillation circuit 202 is variably set with the selection signal S205 and an effective bus width of the output value S203 is variably set with the selection signal S206.

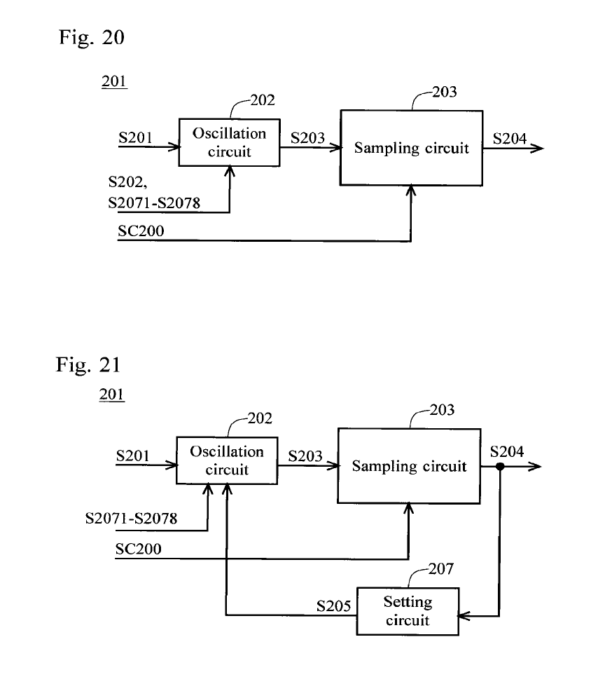

FIG. 20 is a diagram illustrating a configuration of a third modification of the random number generation device 201. The present modification of the random number generation device 201 employs a combination of Embodiment 2-1 (FIG. 9) and Embodiment 2-4 (FIG. 16). An oscillation frequency of the oscillation circuit 202 is variably set with the selection signal S202 and an output bit position from the oscillation circuit 202 is variably set with the selection signals S207 (S2071 to S2078).

FIG. 21 is a diagram illustrating a configuration of a fourth modification of the random number generation device 201. The present modification of the random number generation device 201 employs a combination of Embodiment 2-2 (FIG. 12) and Embodiment 2-4 (FIG. 16). An oscillation frequency of the oscillation circuit 202 is variably set with the selection signal S205 and an output bit position from the oscillation circuit 202 is variably set with the selection signals S207 (S2071 to S2078).

### Embodiment 3-1

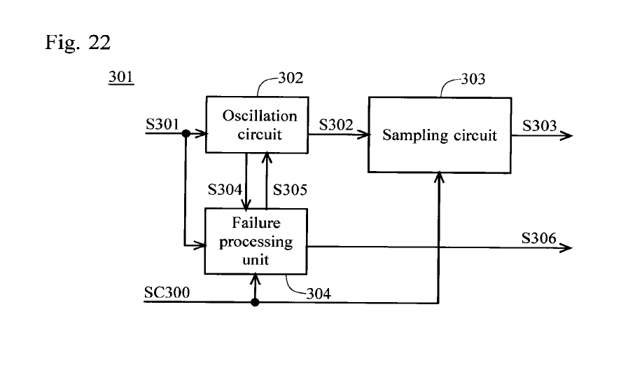

FIG. 22 is a diagram illustrating a configuration of a random number generation device 301 according to Embodiment 3-1 of the present disclosure. FIG. 22 illustrates a connection in the random number generation device 301 including an oscillation circuit 302, a sampling circuit 303, and a failure processing unit 304.

The oscillation circuit 302 outputs an output value S302 having alternating 0 and 1 of two-valued logic. The sampling circuit 303 functions as a random number generation circuit which may include suitable logic, circuitry, interfaces and/or code that may be operable to sample the output value S302 from the oscillation circuit 302, employing a system clock SC300 as a sampling clock, so as to generate a true random number S303.

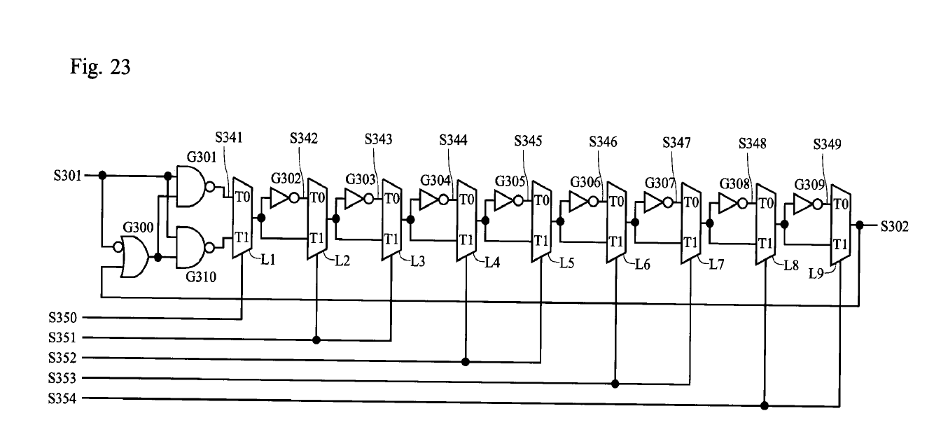

FIG. 23 is a diagram illustrating a configuration of the oscillation circuit 302. FIG. 23 illustrates a connection in the oscillation circuit 302 including multiple logical gates G300 to G310 and multiple selectors L1 to L9. The oscillation circuit 302 includes a logical array having multiple odd number of logical gates connected in serial. In the example of the present embodiment, nine logical gates G301 to G309 are connected in serial via the selectors L1 to L8. The output of the logical gate G309 in the last stage is input to the logical gate G301 in the first stage via the selector L9 and the logical gate G300. Thus the logical gates G301 to G309 of nine stages constitute a ring oscillator. The output value S302 of the oscillation circuit 302 is obtained as an output value from the selector L9.

The logical gate G310 is for replacing the logical gate G301 in the event of a failure. The input terminal T0 of the selector L1 is connected to the output of the logical gate G301, and the input terminal T1 is connected to the output of the logical gate G310. The selector L1 selects one of the input terminals T0 and T1 on the basis of a failure correction value S350 to switch between the logical gates G301 and G310.

The selectors L2 to L9 each include input terminals T0 and T1. The outputs of the logical gates G302 to G309 are connected to the input terminals T0 of the respective selectors L2 to L9. The input terminals T1 of the selectors L2 to L9 are provided with wiring to bypass the respective logical gates G302 to G309.

The selectors L2 and L3, the selectors L4 and L5, the selectors L6 and L7, and the selectors L8 and L9 select one of the input terminals T0 and T1, on the basis of a failure correction value S351, a failure correction value S352, a failure correction value S353, and a failure correction value S354, respectively. For example, if the selectors L2 and L3 select the input terminal T0, the logical gates G302 and G303 are included in the above logical array, while if the input terminal T1 is selected, the logical gates G302 and G303 are bypassed and excluded from the logical array.

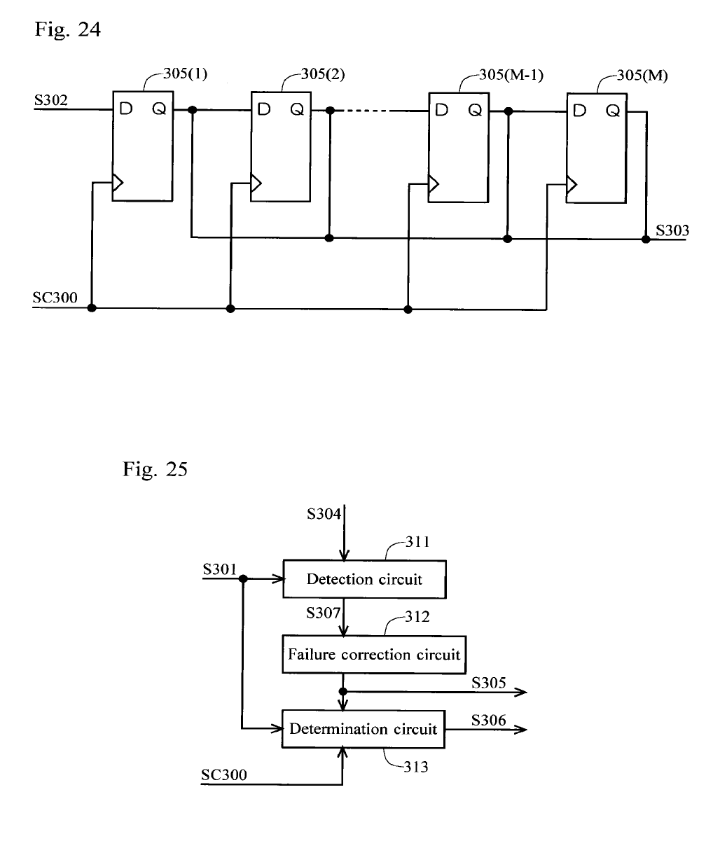

FIG. 24 is a diagram illustrating a configuration of the sampling circuit 303. The sampling circuit 303 includes multiple M number of flip-flops 305(1) to 305(M) connected in serial. Each flip-flop 305 receives a common input of the system clock SC300.

The D terminal of the flip-flop 305(1) in the first stage receives the output value S302 from the oscillation circuit 302. The D terminal of the flip-flops 305(2) to 305(M) in the second and subsequent stages receives an output from the Q terminal of the flip-flops 305(1) to 305(M−1) in the preceding stage. The M number of flip-flops 305(1) to 305(M) are connected in serial, with outputs from each flip-flop 305 being arranged, so that the true random number S303 having M bits in total is output from the sampling circuit 303.

FIG. 25 is a diagram illustrating a configuration of the failure processing unit 304. The failure processing unit 304 includes a detection circuit 311, a failure correction circuit 312, and a determination circuit 313. If a failure occurs in any of the logical gates G301 to G309, the detection circuit 311 detects the failure. When the detection circuit 311 detects a failure in any of the logical gates G301 to G309, the failure correction circuit 312 corrects the failure. The determination circuit 313 functions as a failure notification unit which may include suitable logic, circuitry, interfaces and/or code that may be operable to output a notification signal S306 indicating that an output value (random number S303) from the random number generation device 301 is invalid when the detection circuit 311 detects a failure in any of the logical gates G301 to G309.

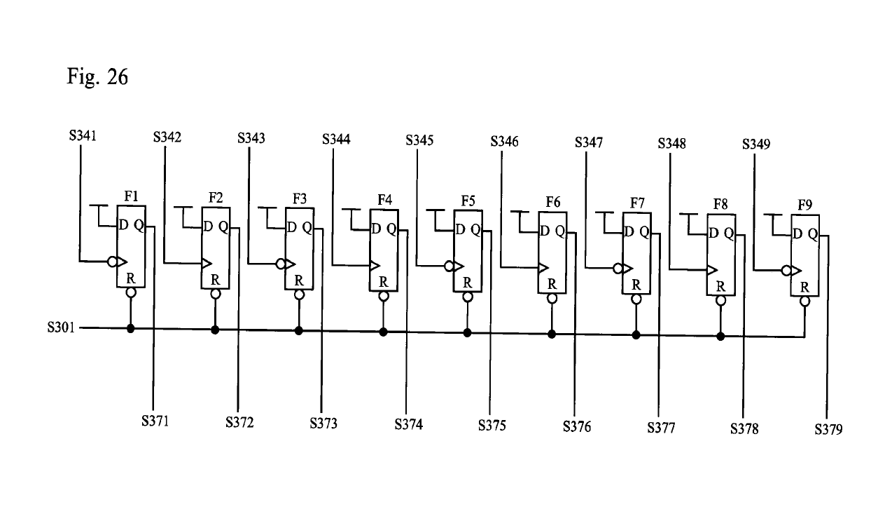

FIG. 26 is a diagram illustrating a detailed configuration of the detection circuit 311. FIG. 26 illustrates a connection in the detection circuit 311 including flip-flops F1 to F9.

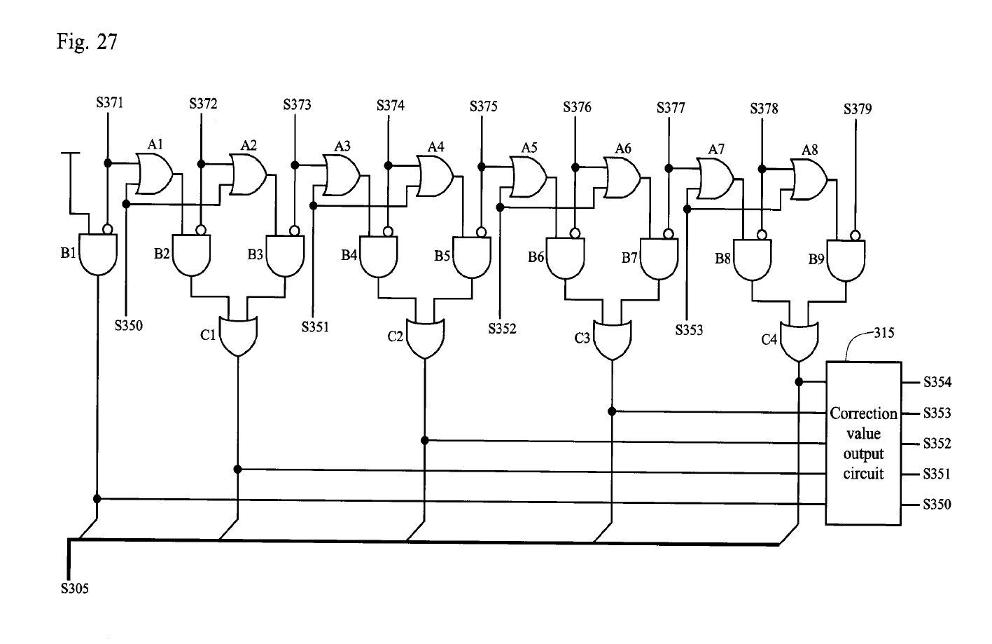

FIG. 27 is a diagram illustrating a detailed configuration of the failure correction circuit 312. FIG. 27 illustrates a connection in the failure correction circuit 312 including logical gates A1 to A8, B1 to B9, and C1 to C4, and a correction value output circuit 315.

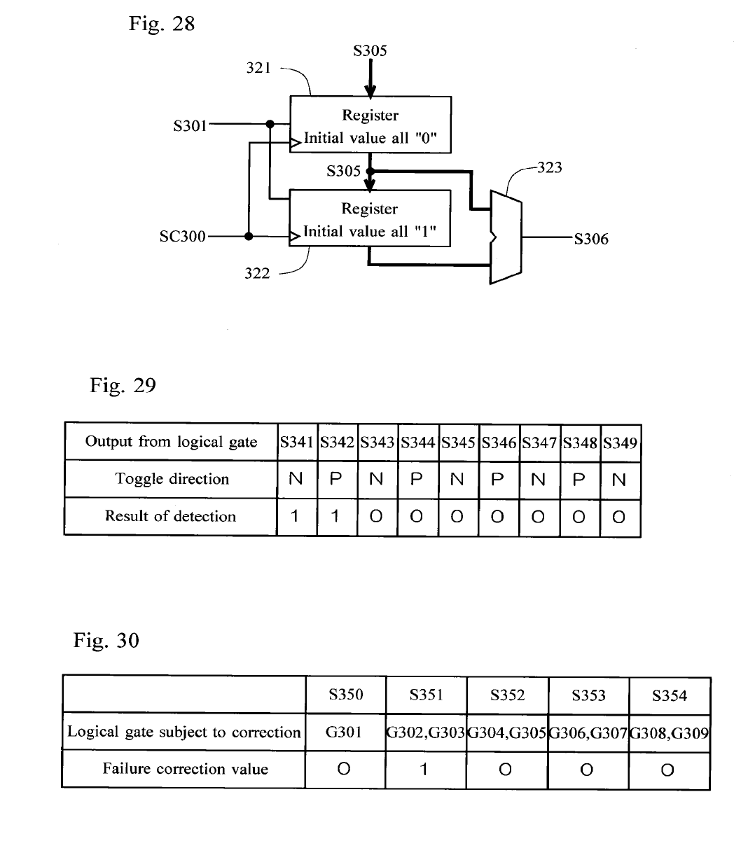

FIG. 28 is a diagram illustrating a detailed configuration of the determination circuit 313. FIG. 28 illustrates a connection in the determination circuit 313 including registers 321 and 322 and a comparator 323.

Description is given below of an operation of the random number generation device 301 according to Embodiment 3-1. The example below describes an operation when a failure occurs in the logical gate G303 in the third stage. All of the failure correction values S350 to S354 are initially set to “0”. The initial value of the register 321 is set to all “0”, and the initial value of the register 322 is set to all “1”.

Referring to FIG. 22, upon assertion of an enabling signal S301, the oscillation circuit 302 starts an oscillation operation. Thus the oscillation circuit 302 outputs the output value S302. The output value S302 is input to the sampling circuit 303.

The sampling circuit 303 samples the output value S302 in synchronization with the system clock SC300. Referring to FIG. 24, the sampled output value S302 is input to and stored in the flip-flop 305(1) in the first stage. Upon receipt of an input of the next system clock SC300, the sampling circuit 303 samples the output value S302 that the oscillation circuit 302 outputs at that time. The sampled output value S302 is input to and stored in the flip-flop 305(1) in the first stage. The output value S302 stored in the flip-flop 305(1) in the first stage until then (output value S302 sampled on the basis of the previous system clock SC300) is shifted from the flip-flop 305(1) in the first stage to the flip-flop 305(2) in the second stage. Operations similar to the above are repeated M times, so that each of the M number of flip-flops 305(1) to 305(M) stores the output value S302. Then the output values S302 stored in the flip-flops 305(1) to 305(M) are output from their Q terminals, with these M number of output values S302 being arranged, so that the random number S303 having M bits in total is output from the sampling circuit 303. The sampling circuit 303 may perform sampling of the output value S302 when a predetermined sampling enabling signal (not illustrated) is input, instead of the system clock SC300.

Referring to FIG. 22, upon assertion of the enabling signal S301, the failure processing unit 304 starts a diagnosis of a failure. Referring to FIG. 26, the output values S341 to S349 from the logical gates G301 to G309 of the oscillation circuit 302 is input to the flip-flops F1 to F9 of the detection circuit 311, respectively. When the output values S341, S343, S345, S347, and S349 are toggled from a level H to a level L and the output values S342, S344, S346, and S348 are toggled from a level L to a level H, the output values S341 to S349 are input to the flip-flops F1 to F9. The detection circuit 311 detects whether the output values S341 to S349 are toggled in the above predetermined direction.

FIG. 29 is a diagram illustrating a result of toggle detection by the detection circuit 311. If a toggle direction (N) from the level H to the level L is detected regarding the output values S341, S343, S345, S347, and S349, the flip-flops F1, F3, F5, F7, and F9 output a result of detection “1” as detection signals S371, S373, S375, S377, and S379, respectively. If a toggle direction (P) from the level L to the level H is detected regarding the output values S342, S344, S346, and S348, the flip-flops F2, F4, F6, and F8 output a result of detection “1” as detection signals S372, S374, S376, and S378, respectively. Since a failure occurs in the logical gate G303 in this example, toggling in the predetermined direction is not detected regarding the output value S343 from the logical gate G303 and subsequent output values S343 to S349, and the result of detection shows “0”.

Referring to FIGS. 26 and 27, the detection signals S371 to S379 are input from the detection circuit 311 to the failure correction circuit 312. The failure correction circuit 312 specifies the logical gate corresponding to the first detection signal having a value “0” among the detection signals S371 to S379 as a failed logical gate. In this example, the logical gate G303 corresponding to the first detection signal S373 having a value “0” is specified as the failed logical gate. The failure correction circuit 312 generates a failure correction signal S305 on the basis of a result of specifying the failed logical gate.

FIG. 30 is a diagram illustrating the failure correction signal S305 (failure correction values S350 to S354) generated by the failure correction circuit 312. If there is no failure occurs in any of the logical gates G301 to G309, the failure correction circuit 312 sets all the failure correction values S350 to S354 to “0”. If a failure occurs in the logical gate G301, the failure correction value S350 is set to “1”. Similarly, if a failure occurs in the logical gate G302 or G303, the failure correction value S351 is set to “1”, if a failure occurs in the logical gate G304 or G305, the failure correction value S352 is set to “1”, if a failure occurs in the logical gate G306 or G307, the failure correction value S353 is set to “1”, and if a failure occurs in the logical gate G308 or G309, the failure correction value S354 is set to “1”. Since a failure occurs in the logical gate G303 in this example, the failure correction value S351 is set to “1”, while the failure correction values S350 and S352 to S354 are set to “0”.

Referring to FIG. 28, the failure correction signal S305 containing the failure correction values S350 to S354 is input from the failure correction circuit 312 to the determination circuit 313. The failure correction signal S305 is input to and stored in the register 321. If any of the failure correction values S350 to S354 is set to “1”, the determination circuit 313 determines that the above logical array contains a failed logical gate, and outputs a notification signal S306 indicating the output value (random number S303) from the random number generation device 301 is invalid. Since the failure correction value S351 is set to “1” in this example, the notification signal S306 indicating that the output value is invalid is output. More specifically, the notification signal S306 is negated, so that the notification signal S306 having a value “0” is output. If all of the failure correction values S350 to S354 are set to “0”, the determination circuit 313 asserts the notification signal S306, so as to output the notification signal S306 having a value “1”.

Referring to FIGS. 23 and 27, the failure correction signal S305 containing the failure correction values S350 to S354 is input from the correction value output circuit 315 to the oscillation circuit 302. Referring to FIG. 23, the selectors L1 to L9 select one of their input terminals T0 and T1 on the basis of the failure correction values S350 to S354. Since the failure correction value S351 is set to “1” and the failure correction values S350 and S352 to S354 are set to “0” in this example, the selectors L2 and L3 select the input terminal T1, while the selectors L1 and L4 to L9 select the input terminal T0. As the selectors L2 and L3 select the input terminal T1, the logical gates G302 and G303 are bypassed and excluded from the above logical array. In consequence, after failure correction, the logical gates G301, and G304 to G309 of seven stages constitute a ring oscillator.

In order to determine whether a failure occurs in the logical gates G304 to G309 in the subsequent stages of the logical gate G303, diagnosis of a failure by the failure processing unit 304 is continued after the failure in the logical gate G303 is corrected. In a similar way to the above, the output values S341 to S349 from the logical gates G301 to G309 are input to the flip-flops F1 to F9 of the detection circuit 311, respectively. The detection circuit 311 detects whether the output values S341 to S349 are toggled in the predetermined direction in a similar way to the above.

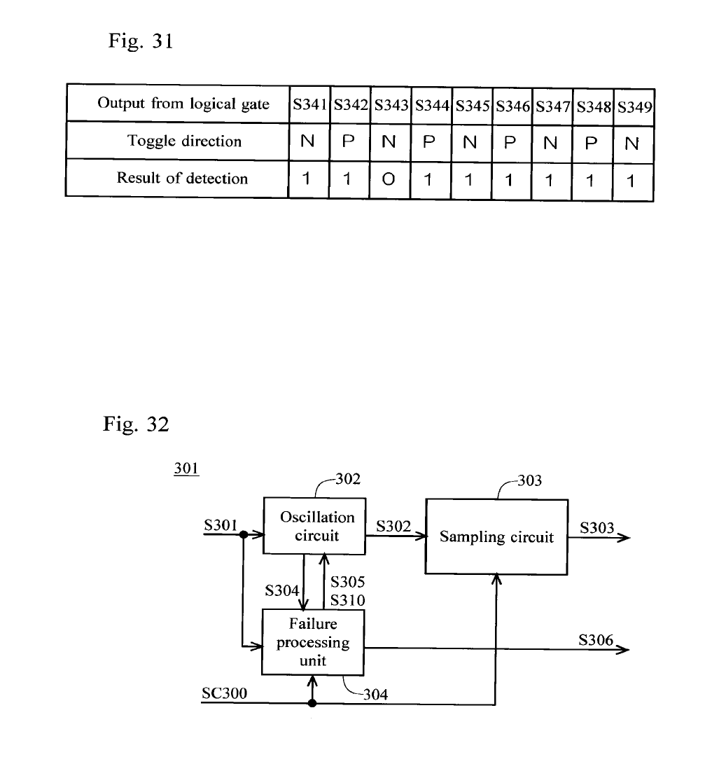

FIG. 31 is a diagram illustrating a result of toggle detection by the detection circuit 311. Since the logical gate G303 is excluded from the logical array in correcting the failure, the result of detection regarding the output values S344 to S349 has been changed to “1” from the state illustrated in FIG. 29.

Referring to FIGS. 26 and 27, the detection signals S371 to S379 are input from the detection circuit 311 to the failure correction circuit 312. The failure correction circuit 312 generates a failure correction signal S305 on the basis of the detection signals S371 to S379 in a similar way to the above. Since a failure occurs in the logical gate G303 and no failure occurs in the other logical gates G301, G302, G304 to G309 in this example, the failure correction value S351 is set to “1”, and the failure correction values S350 and S352 to S354 are set to “0”.

Referring to FIG. 28, the failure correction signal S305 containing the failure correction values S350 to S354 is input from the failure correction circuit 312 to the determination circuit 313. The failure correction signal S305 is input to and stored in the register 321. The previous failure correction signal S305 stored in the register 321 until then is shifted from the register 321 to the register 322. The comparator 323 compares the current failure correction signal S305 stored in the register 321 with the previous failure correction signal S305 stored in the register 322. If the both signals are identical, the notification signal S306 is asserted, so that the notification signal S306 having a value “1” is output, while if the both signals are not identical, the notification signal S306 continues to be negated, so that the notification signal S306 having a value “0” is output. If the both signals are not identical, an error signal may be additionally output. Since the both signals are identical in this example, the notification signal S306 having a value “1” is output from the comparator 323. In other words, the notification signal S306 indicating that the output value (random number S303) from the random number generation device 301 is valid is output.

In the random number generation device 301 according to Embodiment 3-1, if a failure occurs in any of the logical gates G301 to G309 included in the logical gate, the detection circuit 311 detects the failure. If the detection circuit 311 detects a failure in any of the logical gates, an external device that uses the random number S303 is notified of the failure, or alternatively, the failure is corrected in the random number generation device 301, which helps avoid continuous use of the random number generation device 301 when it does not generate an appropriate random number S303.

In the random number generation device 301 according to Embodiment 3-1, the detection circuit 311 detects the output values S341 to S349 from the logical gates that do not toggle in a predetermined direction, for each of the logical gates G301 to G309 included in the logical array, so as to detect the failure in the logical gates. This achieves simple and dependable detection of a failure in a logical gate.

In the random number generation device 301 according to Embodiment 3-1, the determination circuit 313 (failure notification unit) outputs the notification signal S306 indicating that an output value (random number S303) from the random number generation device 301 is invalid, if the detection circuit 311 detects a failure in any of the logical gates. Thus an external device that uses the random number S303 is enabled to suspend the use of the random number S303, upon receipt of an input of the notification signal S306 from the determination circuit 313.

In the random number generation device 301 according to Embodiment 3-1, the failure correction circuit 312 corrects a failure, if the detection circuit 311 detect the failure in any of the logical gates. Since the failure correction circuit 312 corrects the failure in the logical gate and thereby the oscillation circuit 302 outputs an appropriate output value S302, the sampling circuit 303 generates an appropriate random number S303 on the basis of the appropriate output value S302. This helps avoid continuous use of the random number generation device 301 when it does not generate an appropriate random number S303.

In the random number generation device 301 according to Embodiment 3-1, the failure correction circuit 312 corrects the failure by excluding an even number of logical gates including the failed logical gate G303 (two logical gates G302 and G303 in the above example) from a logical array. Correction of a failure in the logical gate G303 is simply achieved by bypassing the failed logical gate G303 to exclude from the logical array. By excluding an even number of logical gates, the logical array after exclusion includes an odd number of logical gates, and thus the output value S302 of the oscillation circuit 302 is correctly oscillated.

### Embodiment 3-2

FIG. 32 is a diagram illustrating a configuration of a random number generation device 301 according to Embodiment 3-2 of the present disclosure. FIG. 32 illustrates a connection in the random number generation device 301 including an oscillation circuit 302, a sampling circuit 303, and a failure processing unit 304. The failure processing unit 304 inputs a frequency correction signal S310 to the oscillation circuit 302, in addition to a failure correction signal S305.

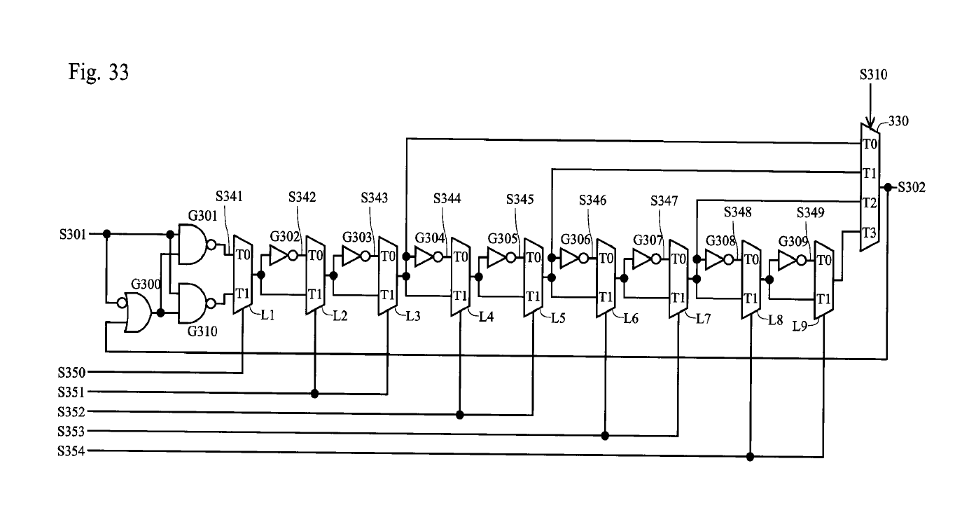

FIG. 33 is a diagram illustrating a configuration of the oscillation circuit 302. A selector 330 is added to the configuration illustrated in FIG. 23. The selector 330 includes input terminals T0 to T3. The input terminals T0, T1, T2, and T3 are connected to an output of the selectors L3, L5, L7, and L9, respectively.

The selector 330 switches between the input terminals T0 to T3 on the basis of the frequency correction signal S310. More specifically, the selector 330 selects the input terminal T0 if the value of the frequency correction signal S310 is “00”, the input terminal T1 if “01”, the input terminal T2 if “10”, and the input terminal T3 if “11”. The output of the selector 330 is connected to inputs of the logical gates G301 and G310 via the logical gate G300.

The value of the frequency correction signal S310 is initially set to “00”, and the selector 330 selects the input terminal T0. Thus the logical array containing the logical gates G301 to G303 of three stages constitute a ring oscillator. The logical gates G304 to G309 function as an auxiliary logical gate.

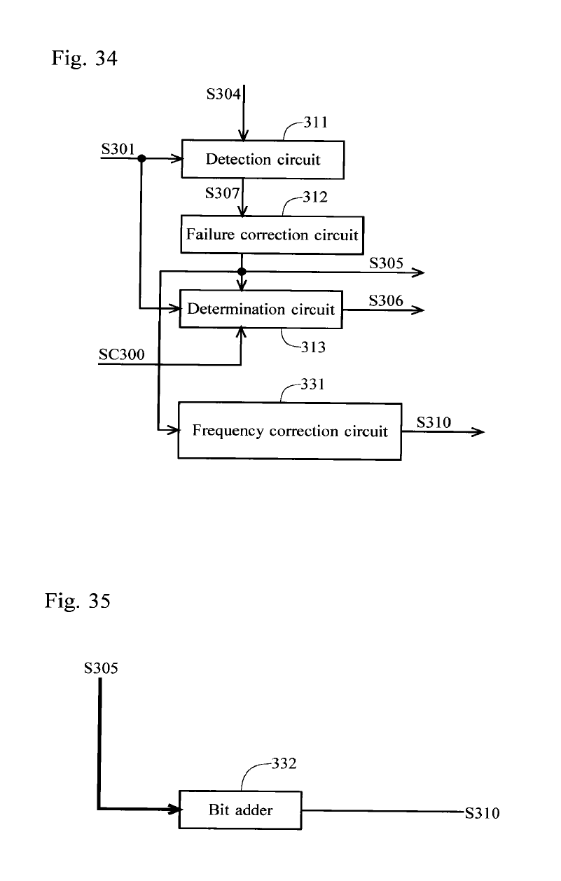

FIG. 34 is a diagram illustrating a configuration of the failure processing unit 304. A frequency correction circuit 331 is added to the configuration illustrated in FIG. 25. The frequency correction circuit 331 adds the same number of auxiliary logical gates as the number of logical gates excluded from the above logical array in failure correction by the failure correction circuit 312 to the above logical array. The configuration of the detection circuit 311, the failure correction circuit 312, and the determination circuit 313 is the same as in Embodiment 3-1 illustrated in FIGS. 26 to 28.

FIG. 35 is a diagram illustrating a detailed configuration of the frequency correction circuit 331. The frequency correction circuit 331 includes a bit adder 332 that adds failure correction values S351 to S354 in the failure correction signal S305.

Description is given below of an operation of the random number generation device 301 according to Embodiment 3-2. The example below describes an operation when a failure occurs in the logical gate G303 in the third stage. All of the failure correction values S350 to S354 are initially set to “0”. The initial value of the register 321 is set to all “0”, and the initial value of the register 322 is set to all “1”.

Referring to FIG. 32, upon assertion of an enabling signal S301, the oscillation circuit 302 starts an oscillation operation. Thus the oscillation circuit 302 outputs the output value S302. The output value S302 is input to the sampling circuit 303.

The sampling circuit 303 samples the output value S302 in synchronization with the system clock SC300 (or a sampling enabling signal not illustrated in the figure).

Upon assertion of the enabling signal S301, the failure processing unit 304 starts a diagnosis of a failure. Referring to FIG. 26, the output values S341 to S343 from the logical gates G301 to G303 constituting the above initial logical array are input to the flip-flops F1 to F3 of the detection circuit 311, respectively. When the output values S341 and S343 are toggled from the level H to the level L and the output value S342 is toggled from the level L to the level H, the output values S341 to S343 are input to the flip-flops F1 to F3. The detection circuit 311 detects whether the output values S341 to S343 are toggled in the above predetermined direction.

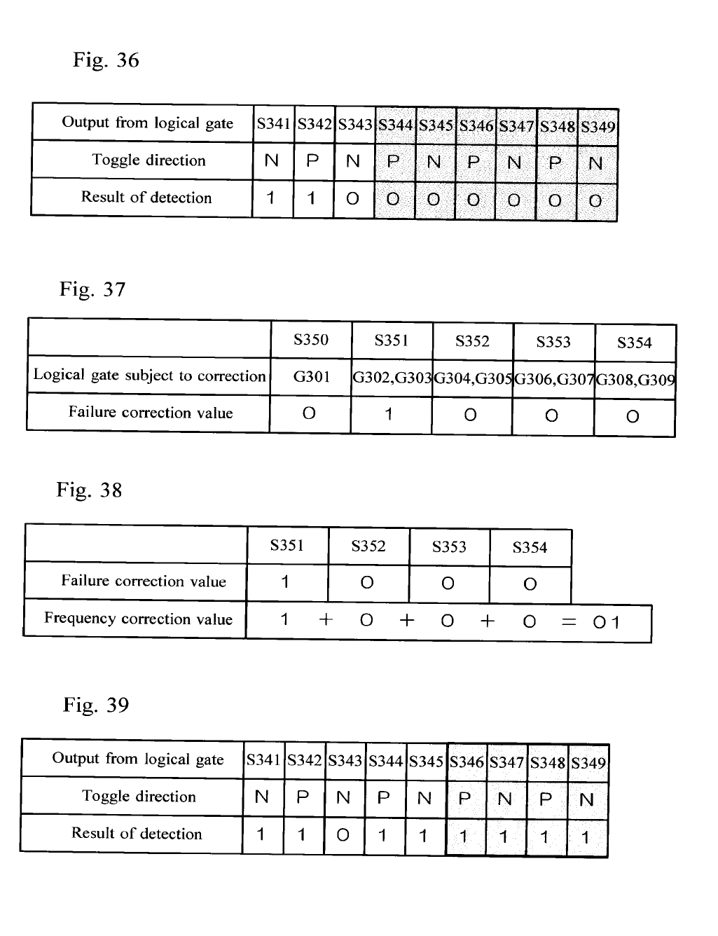

FIG. 36 is a diagram illustrating a result of toggle detection by the detection circuit 311. If a toggle direction (N) from the level H to the level L is detected regarding the output values S341 and S343, the flip-flops F1 and F3 output a result of detection “1” as detection signals S371 and S373, respectively. If a toggle direction (P) from the level L to the level H is detected regarding the output value S342, the flip-flop F2 outputs a result of detection “1” as a detection signal S372. Since a failure occurs in the logical gate G303 in this example, toggling in the predetermined direction is not detected regarding the output value S343 from the logical gate G303, and the result of detection shows “0”.

Referring to FIGS. 26 and 27, the detection signals S371 to S373 are input from the detection circuit 311 to the failure correction circuit 312. The failure correction circuit 312 specifies the logical gate corresponding to the first detection signal having a value “0” among the detection signals S371 to S373 as a failed logical gate. In this example, the logical gate G303 corresponding to the first detection signal S373 having a value “0” is specified as the failed logical gate. The failure correction circuit 312 generates a failure correction signal S305 on the basis of a result of specifying the failed logical gate.

FIG. 37 is a diagram illustrating the failure correction signal S305 (failure correction values S350 to S354) generated by the failure correction circuit 312. Since no failure occurs in the logical gate G301 in this example, the failure correction value S350 is set to “0”. Since a failure occurs in the logical gate G303, the failure correction value S351 is set to “1”. The failure correction values S352 to S354 are set to the initial value “0”.

Referring to FIG. 28, the failure correction signal S305 containing the failure correction values S350 to S354 is input from the failure correction circuit 312 to the determination circuit 313. The failure correction signal S305 is input to and stored in the register 321. If any of the failure correction values S350 and S351 is set to “1”, the determination circuit 313 determines that the above initial logical array contains a failed logical gate, and outputs a notification signal S306 indicating the output value (random number S303) from the random number generation device 301 is invalid. Since the failure correction value S351 is set to “1” in this example, the notification signal S306 indicating that the output value is invalid is output.

Referring to FIG. 35, the failure correction signal S305 containing the failure correction values S350 to S354 is input from the failure correction circuit 312 to the frequency correction circuit 331.

FIG. 38 is a diagram illustrating the frequency correction signal S310 generated by the frequency correction circuit 331. The frequency correction circuit 331 adds the failure correction values S351 to S354 with the bit adder 332, so as to generate a frequency correction value. In this example, the failure correction value S351 is “1” and the failure correction values S352 to S354 are “0”, and accordingly the frequency correction value is “01” of 2 bits. The frequency correction signal S310 containing the frequency correction value“01” is input from the frequency correction circuit 331 to the oscillation circuit 302.

Referring to FIGS. 33 and 27, the failure correction signal S305 containing the failure correction values S350 to S354 is input from the correction value output circuit 315 to the oscillation circuit 302. Referring to FIG. 33, the selectors L1 to L9 selects one of their input terminals T0 and T1 on the basis of the failure correction values S350 to S354. Since the failure correction value S351 is set to “1” and the failure correction values S350 and S352 to S354 are set to “0” in this example, the selectors L2 and L3 select the input terminal T1, while the selectors L1 and L4 to L9 select the input terminal T0. As the selectors L2 and L3 select the input terminal T1, the logical gates G302 and G303 are bypassed and excluded from the above initial logical array. Upon receipt of an input of the frequency correction signal S310 containing the frequency correction value“01”, the selector 330 selects the input terminal T1. In consequence, the logical gates G301, G304, and G305 of three stages constitute a ring oscillator. In other words, the logical gates G302 and G303 are excluded from the initial logical array in correcting the failure, and the logical gates G304 and G305 are added instead in correcting the frequency, so that the number of stages in the ring oscillator and the oscillation frequency are maintained.

In order to determine whether a failure occurs in the added logical gates G304 and G305, diagnosis of a failure by the failure processing unit 304 is continued after failure correction and frequency correction. In a similar way to the above, the output values S341 to S345 from the logical gates G301 to G305 are input from the flip-flops F1 to F5 of the detection circuit 311. The detection circuit 311 detects whether the output values S341 to S345 are toggled in the predetermined direction in a similar way to the above.

FIG. 39 is a diagram illustrating a result of toggle detection by the detection circuit 311. Since no failure occurs in the logical gates G304 and G305 in this example, the result of detection regarding the output values S344 and S345 is “1”.

Referring to FIGS. 26 and 27, the detection signals S371 to S375 are input from the detection circuit 311 to the failure correction circuit 312. The failure correction circuit 312 generates a failure correction signal S305 on the basis of the detection signals S371 to S375 in a similar way to the above. Since a failure occurs in the logical gate G303 and no failure occurs in the other logical gates G301, G302, G304, and G305 in this example, the failure correction value S351 is set to “1”, and the failure correction values S350 and S352 are set to “0”. The failure correction values S353 and S354 are set to the initial value “0”.

Referring to FIG. 28, the failure correction signal S305 containing the failure correction values S350 to S354 is input from the failure correction circuit 312 to the determination circuit 313. The failure correction signal S305 is input to and stored in the register 321. The previous failure correction signal S305 stored in the register 321 until then is shifted from the register 321 to the register 322. The comparator 323 compares the current failure correction signal S305 stored in the register 321 with the previous failure correction signal S305 stored in the register 322. If the both signals are identical, the notification signal S306 is asserted, so that the notification signal S306 having a value “1” is output, while if the both signals are not identical, the notification signal S306 continues to be negated, so that the notification signal S306 having a value “0” is output. Since the both signals are identical in this example, the notification signal S306 having a value “1” is output from the comparator 323. In other words, the notification signal S306 indicating that the output value (random number S303) from the random number generation device 301 is valid is output.

In the random number generation device 301 according to Embodiment 3-2, the frequency correction circuit 331 adds the same number of auxiliary logical gates (logical gates G304 and G305 in the above example) as the number of logical gates (the logical gates G302 and G303 in the above example) excluded from the logical array by the failure correction circuit 312 to the logical array. Since the number of logical gates constituting the logical array is the same between before and after exclusion, the oscillation frequency of the oscillation circuit 302 is effectively maintained.

While the invention has been described in detail, the foregoing description is in all aspects illustrative and not restrictive. It is understood that numerous other modifications and variations can be devised without departing from the scope of the invention.

What is claimed is:

1. A random number generation device comprising:
a circuitry configured to:
output an output value of alternating 0 and 1 of two-valued logic;
determine a sampling timing by generating data in which a value changes irregularly based on the output value; and
generate a random number by sampling the output value at the sampling timing.

2. The random number generation device according to claim 1, wherein
the circuitry is further configured to generate a pseudo random number, employing the output value as a seed.

3. The random number generation device according to claim 2, wherein
the circuitry is further configured to:
count a system clock from a predetermined initial value; and
output a control signal for causing to perform sampling of the output value when a count number of the system clock matches a value of the pseudo random number.

4. The random number generation device according to claim 2, wherein
the circuitry is further configured to:
count a system clock, employing the output value as an initial value; and
output a control signal for causing to perform sampling of the output value when a count number of the system clock matches a value of the pseudo random number.

5. The random number generation device according to claim 2, wherein
the circuitry is further configured to output a control signal for causing to perform sampling of the output value, when a value of the pseudo random number matches a preset predetermined value.

6. The random number generation device according to claim 2, wherein
the circuitry is further configured to suspend outputting of the output value and generation of the pseudo random number in a period when generation of a random number is not required.

7. The random number generation device according to claim 1, wherein
the circuitry is further configured to count a system clock, employing the output value as an initial value.

8. The random number generation device according to claim 7, wherein
the circuitry is further configured to:
generate a pseudo random number, employing a predetermined value as a seed; and
output a control signal for causing to perform sampling of the output value when a count number of the system clock matches a value of the pseudo random number.

9. The random number generation device according to claim 7, wherein
the circuitry is further configured to output a control signal for causing to perform sampling of the output value when a count number of the system clock matches a preset predetermined value.

10. The random number generation device according to claim 7, wherein
the circuitry is further configured to suspend outputting of the output value and counting of the system clock in a period when generation of a random number is not required.

11. A method for generating a random number comprising:
generating an output value of alternating 0 and 1 of two-valued logic;
determining a sampling timing by generating data in which a value changes irregularly based on the generated output value; and
generating a random number by sampling the generated output value at the determined sampling timing.

12. A random number generation device comprising:
an oscillation circuit configured to output an output value of alternating 0 and 1 of two-valued logic;
a controller configured to determine a sampling timing by generating data in which a value changes irregularly based on the output value from the oscillation circuit; and
a random number generation circuit configured to generate a random number by sampling the output value from the oscillation circuit at the sampling timing determined by the controller.
